(19) United States
(12) Patent Application Publication
(10) Pub. No.: US 2026/0071872 A1
(43) Pub. Date: Mar. 12, 2026

(54) Method and System for Wavelet Compression as an Observational Operator in Data Assimilation Systems for Sea Surface Temperature

(71) Applicant: The Government of the United States of America, as represented by the Secretary of the Navy, Arlington, VA (US)

(72) Inventors: Joseph M. D'Addezio, Slidell, LA (US); Hans Ngodock, Slidell, LA (US); Bradley Sciacca, New Orleans, LA (US); Innocent Souopgui, Slidell, LA (US); Matthew Carrier, Covington, LA (US); Ivo Pasmans, Reading (GB)

(73) Assignee: The Government of the United States of America, as represented by the Secretary of the Navy, Arlington, VA (US)

(21) Appl. No.: 19/318,896

(22) Filed: Sep. 4, 2025

Related U.S. Application Data
(60) Provisional application No. 63/691,438, filed on Sep. 6, 2024.

(51) Int. Cl. G01C 13/00; G01K 13/02

(52) U.S. Cl. CPC G01C 13/004; G01K 13/026

(57) ABSTRACT

A method includes converting, via a wavelet transform, (i) data associated with a prior ocean state forecast to wavelet space prior ocean state data and (ii) ocean observations to wavelet space observation data, and then filtering the wavelet space observation data. The method includes generating a correction value based on a difference between the wavelet space prior ocean state data and the filtered observation data, and determining a wavelet space increment value based on (i) the generated correction value, (ii) an error covariance associated with the prior ocean state forecast, and (iii) an error covariance associated with the ocean observations. The method includes converting, via an inverse of the wavelet transform, the wavelet space increment value to a physical space increment value, and generating a current ocean state forecast based on (i) the converted physical space increment value and (ii) a background state associated with the prior ocean state forecast.

### CROSS-REFERENCE

This Application is a nonprovisional application of and claims the benefit of priority under 35 U.S.C. § 119 based on U.S. Provisional Patent Application No. 63/691,438 filed on Sep. 6, 2024. The Provisional Application and all references cited herein are hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #212239.

### TECHNICAL FIELD

The present disclosure is related to, but not limited to, forecasting an ocean state via assimilation of ocean observations, and more specifically to transitioning the data assimilation system from physical space to wavelet space via a novel method.

### BACKGROUND

Due to necessary assumptions of observational errors with an exigency for appropriate and timely inversion in the assimilation, dense observations are thinned and/or altered before being assimilated into ocean models. Historically, this process did not significantly restrict model skill because most of the observation types had a quite coarse horizontal distribution. There exists a need for a solution whereby small-scale features are actively corrected in the model background.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

Disclosed aspects provide a method of forecasting an ocean state via assimilation of ocean observations. The method may include receiving, by a processing device, data associated with a prior ocean state forecast, and converting, by the processing device, via a wavelet transform, the data associated with the prior ocean state forecast to wavelet space prior ocean state data, wherein the wavelet transform converts a signal from physical space to wavelet space. The method may include converting, by the processing device, via the wavelet transform, the ocean observations to wavelet space observation data, and filtering, by the processing device, the wavelet space observation data to generate filtered observation data. The method may include generating, by the processing device, a correction value based on a difference between the wavelet space prior ocean state data and the filtered observation data, the correction value being in wavelet space, and determining, by the processing device, a wavelet space increment value based on (i) the generated correction value, (ii) an error covariance associated with the prior ocean state forecast, and (iii) an error covariance associated with the ocean observations. The method may include converting, by the processing device, via an inverse of the wavelet transform, the wavelet space increment value to a physical space increment value, and generating, by the processing device, a current ocean state forecast based on (i) the converted physical space increment value and (ii) a background state associated with the prior ocean state forecast.

### BRIEF DESCRIPTION OF THE DRAWINGS

FIG. 1, in accordance with one or more disclosed aspects: (a) Input SST image with average magnitude of 11. (b) Level one 2D wavelet transform of (a) where H1, V1, and D1 are respectively the level 1 horizontal, vertical, and diagonal detail coefficients with respectively average magnitude of 1.2×10\hat{ }(−2),4.0×10\hat{ }(−4), and 1.2×10\hat{ }(−2). A is the approximation coefficients with average magnitude of 22. (c) Level two 2D wavelet transform of (a) where H2, V2, and D2 correspond to the level 2 details, they have respective magnitude 4.7×10\hat{ }(−3),2.6×10\hat{ }(−4), and 2.8×10\hat{ }(−3). The first level details are the same as in (b). The approximation coefficients now have an average magnitude of 44. (d) The inverse wavelet transform of c with all the detail coefficients thresholded to 0. The average magnitude is still 11.

FIG. 2, in accordance with one or more disclosed aspects: (a) Raw innovation for the first day of assimilation. With low observational error this show cases the best-case of information retained from the observation. (b) Superobs increment on the model grid, without post-multiplication by B. This shows the sparsity that arises from the superob observation operator when it returns the state to the model grid. (c) Increment, after applying the background covariance operator to b. This spreads the information spatially on the model grid.

FIG. 3, in accordance with one or more disclosed aspects: (a) Horizontal correlation scales from NCODA, “Rossby scale”. (b) Vertical correlation scales from NCODA. (c) Wavelet approximation filter frequency response, showing the ¼ power cutoff per level of wavelet transform. This cutoff is “wavelet scale” as it represents what wavelengths are retained after keeping only approximation coefficients after the wavelet transform observation operator.

FIG. 4, in accordance with one or more disclosed aspects: Similar to FIG. 2, but for Wavelet-3DVAR. (a) Raw innovation for the first day of assimilation. (b) The increment on the model grid prior to application of the background covariance operator, at Rossby scale. Showing information present at every model grid location (c) Same as b but for the length scale at wavelet scale. Showing more small-scale information present at every model grid location. (d) Increment at Rossby scale (e) Increment at wavelet scale. These show that the wavelet observation operator brings information to every grid point, and the background error covariance operator smooths out to its' length scale, with the background variance adjusting the magnitude.

FIG. 5, in accordance with one or more disclosed aspects: Demonstration of the footprint in the creation of superobs. σ_0\hat{ }2 is the per model grid variance, α_s\hat{ }2 is the variance assigned to superobs, and C is the horizontal correlation scale. One of the white boxes represents a single model grid point, the blue shaded region is the footprint of superobs from NCODA, and the red dashed circle is the theoretical footprint for superobs. The shaded red region is the single grid point this particular superob would be placed at.

FIG. 6, in accordance with one or more disclosed aspects: Example of the radial averaging of the Power Spectral Density (PSD). (Top) shows a few example wavenumber radii at which all points on the 2D PSD that would fall on such radii would be averaged to that wavelength on the bottom. (Bottom) Example 1D PSD created from the top plot as explained in section 2.5.

FIG. 7, in accordance with one or more disclosed aspects: Select 30-day apart error plots given by Eq. 11. Wavelet RS is wavelet-3DVAR at Rossby scale. Wavelet WS is wavelet-3DVAR at wavelet scale. Clouded Wavelet is the clouded wavelet-3DVAR at wavelet scale. Spatially averaged RMSE is given for each respective day.

FIG. 8, in accordance with one or more disclosed aspects: (a) Daily RMSE of all experiments given by equation 12. (b) Zoom of a, showing Rossby scale experiments. (c) A zoomed version of a, ignoring the Free run.

FIG. 9, in accordance with one or more disclosed aspects: (a) Depth RMSE of all experiments given by equation 13. (b) Zoomed in a, ignoring the Free run and looking down to 5 meters to see the finer differences between the experiments at the near surface.

FIG. 10, in accordance with one or more disclosed aspects: (a) Constrained scales given by Eq 15. The more a particular experiment is below 1.0, the more it is considered to have “constrained” all wavelengths before the 1.0 crossing as explained in section 2.5. This is effectively showing the power per wavelength in the assimilative error in each experiment. (b) Zoomed in on Rossby scale results. (c) Zoomed in on wavelet scale results. The numbers on b and c indicate the 1.0 crossing in km.

FIG. 11, in accordance with one or more disclosed aspects: (a) Example clouded observation on January 11th, showing roughly the average coverage. (b) Percent of original observation that is covered by clouds over the entire six months, dashed line indicates temporal average.

FIG. 12 illustrates a schematic of an exemplary Navy Coupled Ocean Data Assimilation (NCODA) flow diagram, in accordance with one or more disclosed aspects.

FIG. 13 illustrates a schematic of a conventional system, in accordance with one or more disclosed aspects.

FIG. 14 illustrates a schematic of a novel system for forecasting an ocean state via assimilation of ocean observations, in accordance with one or more disclosed aspects.

FIG. 15 illustrates a schematic of exemplary filtering, in accordance with one or more disclosed aspects.

FIG. 16 illustrates a diagram of a comparison of exemplary systems, in accordance with one or more disclosed aspects.

FIG. 17 illustrates a diagram of a comparison of exemplary systems, in accordance with one or more disclosed aspects.

FIG. 18 illustrates a schematic of a novel system for forecasting an ocean state via assimilation of ocean observations, in accordance with one or more disclosed aspects.

FIG. 19 illustrates various mother wavelets, in accordance with one or more disclosed aspects.

FIG. 20 illustrates example error metrics, in accordance with one or more disclosed aspects.

FIG. 21 illustrates an example method, in accordance with one or more disclosed aspects.

FIG. 22 illustrates an example computer system, in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

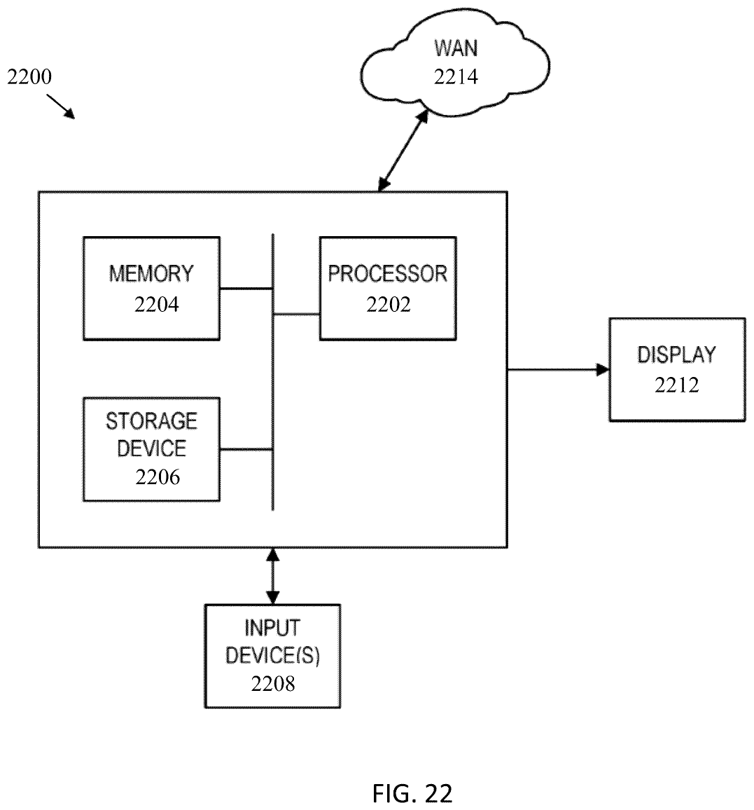

Disclosed embodiments provide for a novel system and method that applies multiscale data assimilation utilizing the wavelet transform. One or more aspects described herein may be performed by a computer, computing device, processing device, or the like, such as the one described herein and/or shown in FIG. 22.

Disclosed embodiments transition the data assimilation system from physical space to wavelet space, using, for example, the wavelet transform. The wavelet transform can be used to convert the observations (y) and model background (x_{b}) to wavelet space and filtered to a user specified spatial scale. In wavelet space (note y′ and x_{b}′), the data assimilation problem can be solved, and the solution can be converted back to physical space to correct the model (W^{T} to inverse back to physical space).

Unlike other currently employed ocean multiscale techniques, the disclosed method can be performed in a single analysis step. Utilizing the wavelet transform allows for observational information to be retained at all its original grid points, compared to the averaging and removal in traditional techniques, such as super observations. This comes from the unique space and frequency relation available to the wavelet transform, which instead filters the potentially correlated small-scale observation errors at each model grid point. Several six-month identical twin data assimilation experiments were used to validate the method. Results indicate comparable to substantial improvements over super observations. On average, the sea surface temperature RMSE was 39% lower for the wavelet method over the six-months compared to super observations. The wavelet method was also able to constrain horizontal scales in assimilation 29 km and above compared to 60 km and above for the super observations.

### 1. Introduction

For the first time in history, the capabilities of observing networks have the potential to capture and constrain sub-mesoscale ocean dynamics. Yet, paradoxically, the current best practices in ocean data assimilation tend to discard most of the high-resolution content within the observations (de Rosnay, et al. 2022). Model resolution and necessary assumptions about the structure of the model and observation errors lead to data thinning (Cummings 2006, Ochotta, et al. 2007; Liu and Rabier 2002; Hoffman 2018). Cummings (2006) argues that “thinning of observations is a necessary step in the analysis in order to remove redundancies in the data and minimize horizontal correlations among observations.” Data thinning is the process of using a subset of available observations. To a similar effect, one may also average subsets of available observations to make super observations, or superobs. Many established systems, such as the Navy Coupled Ocean Data Assimilation (NCODA), use superobs. In the computation of superobs, observations are averaged together, weighted by the horizontal correlation scale, to contain roughly 0.2% of the original information. For example, superobs would take a dense field of Sea Surface Temperature (SST) observations with grid dimensions 1222×1066 (≤1,302,652 points of information depending on geography) and reduce it to just 1,519 averaged data points. These reductions generally lead to only large-scale corrections in the model during assimilation even when the original information is of much higher resolution.

To address this loss of information in three-dimensional variational data assimilation (3DVAR), so called multiscale data assimilation methods have been developed (Li, et al. 2015; Souopgui, D'Addezio, et al. 2020; Muscarella et al. 2014). The most implemented multiscale algorithm performs a two-step assimilation. Large-scale corrections are computed first, followed by small-scale corrections, each with corresponding error variances, correlations, and correlation scales. The method is effective but still relies on superobs, whereby a smaller decorrelation scale in the second analysis step results in a set of superobs that retain more small-scale information. Recently, Jacobs et al. (2023) demonstrated that multiscale assimilation is possible with one assimilation step by using an adaptive horizontal correlation scale. This method was also quite effective but still relied on removal of information using superobs by adaptively retaining more small-scale information in regions containing dense observations. Ensemble based methods also show a wide variety of multiscale techniques (Buehner and Shlyaeva 2015; Wang, et al. 2021). Specifically, Bédard and Buehner (2020) utilized spatial-difference observations for assimilation and Ying (2020) tried assimilating Fourier-based observation scale components, both methods demonstrating that removed observation information can still be used in multi-step assimilation approaches.

Here we describe a novel multiscale method that is also one-step, utilizing the wavelet transform, which removes the need for superobs altogether. The wavelets-based method differs from the previously introduced multiscale methods by 1) retaining information at all observation locations, and 2) filtering the content of the information to achieve similar goals. Our aim is to provide a realistic proof-of-concept of the technique, highlighting the use of the wavelet transform as an alternative to superobs. Direct comparison to current multiscale methods will be left for future work.

The wavelet transform is a decomposition of input data into orthogonal (or biorthogonal) sets of basis functions called wavelets. This is analogous to the well-known Fourier transform, but the latter is restricted to using sine and cosine as basis functions. In contrast, the wavelet transform has a much diverse set of basis functions. Further, because of the continuous nature of sine and cosine functions, the Fourier transform cannot provide localized frequency information unless the signal is windowed, which then adversely affects the frequency resolution. Wavelets are compactly defined in space (or time), which allows for both space (or time) and wavenumber (or frequency) resolution. Wavelet transform data assimilation or wavelet-3DVAR (see section 2.3) brings both the observations and model background into a compatible wavelet space, which can also be thought of as a synchronization space (Penny, et al. 2022). The observations are “pre-processed” into wavelet space at the start of the analysis cycle and the wavelet transform acts as an observation operator on the model background state. This method performs best on data that are in the form of maps: discrete signals that consistently carry numerical information and do not contain large gaps with missing values. In a generalized view, the wavelet transform splits data into two categories: low-frequency and high-frequency wavelet coefficients, called approximation and details respectively. Compared to the multiscale methods above, the main advantage of this method is that by removing all detail wavelet coefficients during the assimilation (i.e., thresholding), the same filtering goals achieved by superobs are followed. However, the inverse wavelet transform may reconstruct the data at each original observation location using only the remaining approximation wavelet coefficients, this allows slight alteration to the content of the information instead of absolute removal like in the case of superobs.

Previous studies on the mixture of the wavelet transform with data assimilation have shown some favorable results. Tangborn (2004) reduced the computational cost of applying the error covariance matrix in a Kalman filter assimilation scheme through the use of wavelet compression. Beezley, Mandel and Cobb (2011) utilized the wavelet transform instead of the Fast Fourier Transform, which led to improvement over traditional ensemble Kalman filter methods. Souopgui, Wieland, et al. (2016) utilized wavelet compression on a space-time grid in a 4DVAR method. Hickmann and Godinez (2017) constructed a multiresolution ensemble Kalman filter using the wavelet transform. The application of wavelets in ocean data assimilation presented in disclosed abstracts differs from these prior works by focusing on the unique filtering allowed by the wavelet transform to assimilate observations more efficiently when they capture multiple scales of motion.

The method was implemented and tested using an identical twin data assimilation experiment (Yu, et al. 2019 and Atlas 1997). There were a total of four experiments conducted in this study, three for wavelet-3DVAR and one for superobs. The first experiment was to compare wavelet-3DVAR to superobs in a “apples to apples” comparison. The second was then to demonstrate the further capability of the wavelet method when not forced to abide by limiting assumptions required for direct comparison with superobs. Finally, we carried out a more realistic experiment utilizing the wavelet method in which we add simulated clouds to the observations. Experiments assimilated SST observations herein. These observations have overall good spatial coverage and are naturally multiscale.

As described, the methods section 2.1 addresses the background information of the wavelet transform. Section 2.2 provides the framework for the scheme used to compute the superobs analysis as well as the reason they are computed in the first place. Section 2.3 goes over the wavelet method, wavelet-3DVAR. Section 2.4 describes the experimental methodology and verification using an identical twin data assimilation experiment and its initialization as well as the specifications on the model used in the experiments. Section 2.5 shows the mathematical methods used to examine and quantify the results. Section 3.1 demonstrates the results of the “apples to apples” experiment, 3.2 is the results of the wavelets with no limiting assumption with respect to horizontal scales, and 3.3 is the results for the clouded experiment. Finally, conclusions are presented in section 4.

Disclosed embodiments were created in order to more effectively assimilate high-resolution ocean observations into the United States Navy's regional ocean model: Navy Coastal Ocean Model (NCOM). Data assimilation is a mathematical process by which recent observations are used to update a model (e.g. NCOM). Disclosed embodiments provide a better initial condition to the model and ultimately a more accurate ocean forecast (i.e., estimate of future ocean state).

Over the last decade, ocean observations, particularly those made from space, have been made at significantly higher horizontal resolution. This allows oceanographers to understand and ultimately predict smaller scale ocean features. However, increasing resolution usually comes with the downsides of increased 1) observation redundancy and 2) observation error correlation. These two effects have serious implications for ocean data assimilation. If observations over a predefined horizontal decorrelation scale are highly redundant, the process by which a solution to the data assimilation problem is solved can slow down significantly. Further, the Navy ocean data assimilation system assumes that observations are uncorrelated in space. If this is not true, which can often be the case for very high-resolution observations, the assimilation system can either slow down significantly or even become unable to generate a solution. Both of these problems pose a serious challenge for current ocean data assimilation methods and state-of-the-art methods exist to deal with them.

To both reduce observation redundancy and error correlation, high-resolution observations are routinely filtered before they are assimilated into an ocean model. This filtering procedure is standard across the ocean data assimilation community. The most common algorithm, and the current state-of-the-art, used to filter the observations is called ‘superobservations’. The superobservation algorithm performs a weighted average over a predefined horizontal decorrelation scale and uses that filtered result as the final observation to be assimilated into the ocean model (Cummings, 2006). This filtering method is a harsh, irreversible low-pass filter that significantly reduces the amount of high-resolution information that gets assimilated into the ocean model. Disclosed embodiments utilizes wavelets in order to both filter the observations and allow much more small-scale information to be assimilated into the ocean model. Therefore, disclosed embodiments produce a significantly better update to the ocean model state than prior methods.

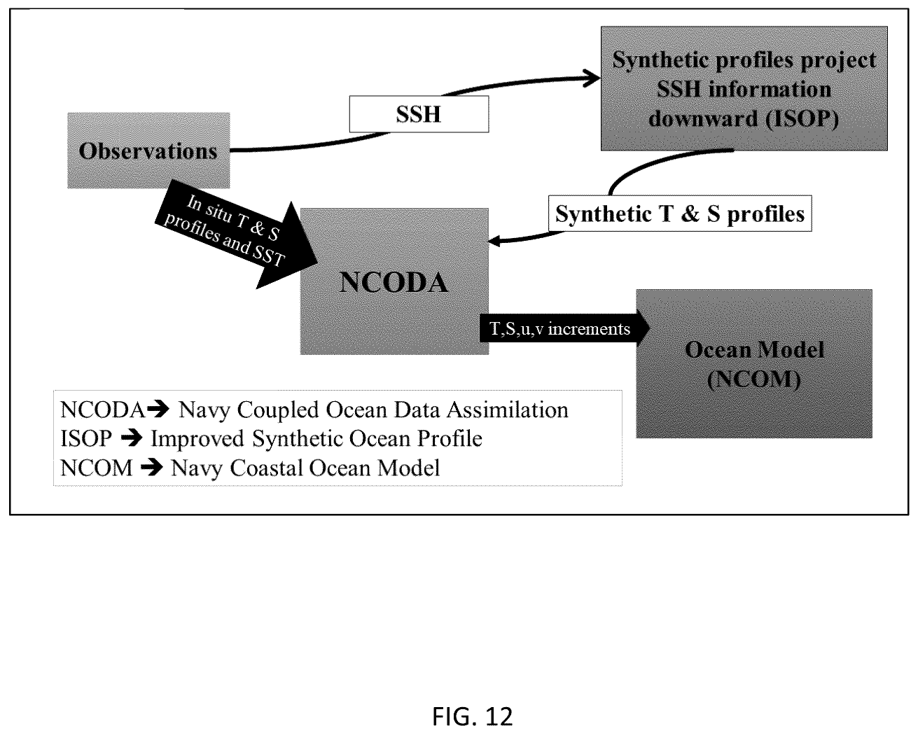

Disclosed embodiments can be implemented inside the Navy's operational ocean data assimilation system: Navy Coupled Ocean Data Assimilation (NCODA). A general schematic of NCODA is illustrated in FIG. 12.

NCODA assimilates observations of sea surface temperature (SST), in situ profiles of temperature and salinity, and sea surface height (SSH) into a ‘background’, typically the prior 24-hour ocean model forecast (i.e. NCOM). The ultimate result of the NCODA system is an ‘increment’ field, essentially the best estimated correction of the background based on the available observations. This increment is added to the ocean model background and that ‘analysis’ is the integrated forward using the ocean model to generate a new forecast of the future ocean state.

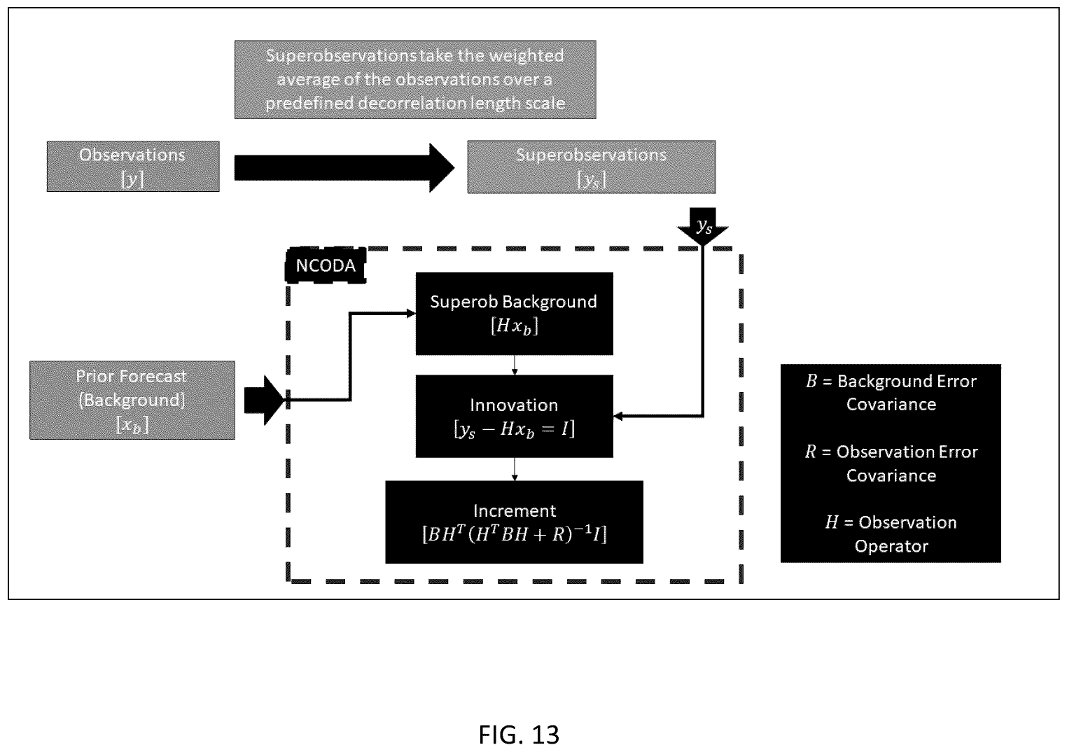

Observations can be filtered to deal with observation redundancy and observation error correlation. A conventional method with respect to conventional filtering can be illustrated in FIG. 13.

These filtered observations are called ‘superobservations’. They are created as a pre-processing step of the observations outside of the NCODA assimilation system. Over a user defined decorrelation length scale, a weighted average is performed to reduce many observations into a single superobservation. The field of superobservations are then put into NCODA. The observation operator, H, maps the ocean model background (x_{b}) to the superobservation in time and space and is then subtracted from the superobservation to generate the ‘innovation’. Using linear algebra and gradient descent calculus, the increment is calculated based on the innovation, assumptions about errors in the model background (B), and assumptions about the observation errors (R). This entire process is performed in physical space, a significant difference from disclosed embodiments.

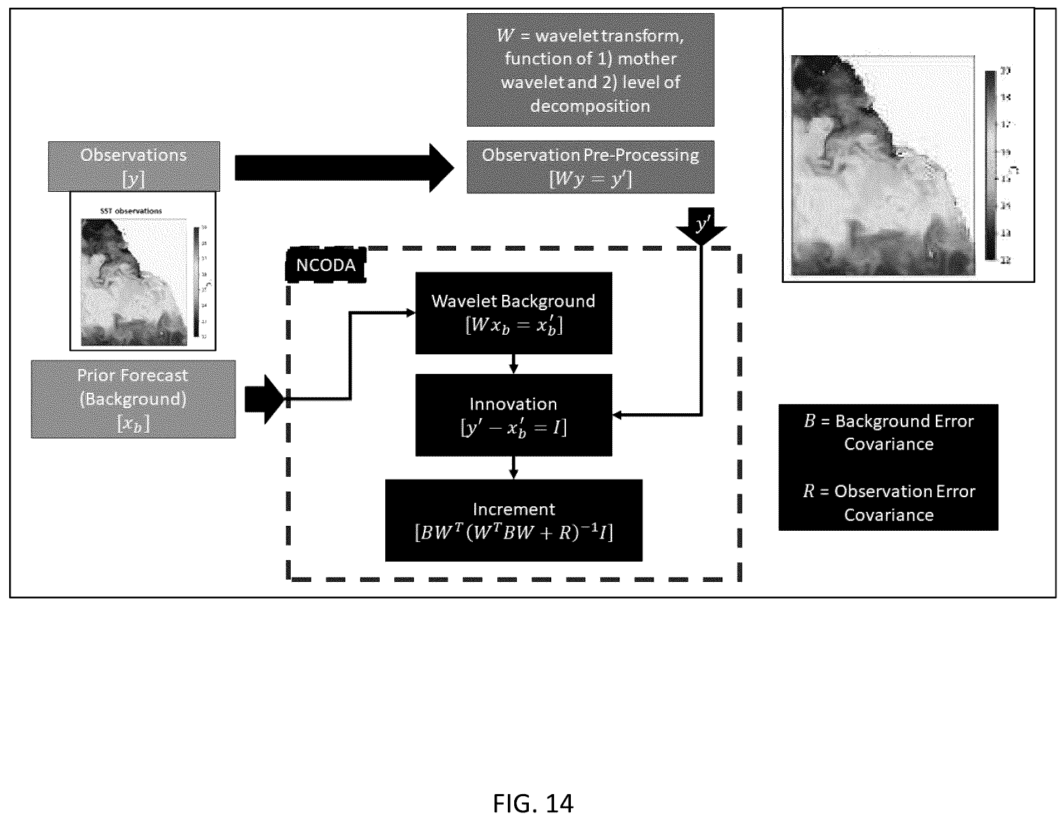

Disclosed embodiments perform a pre-process filtering of the observations and can be implemented within the NCODA system, such as illustrated in FIG. 14.

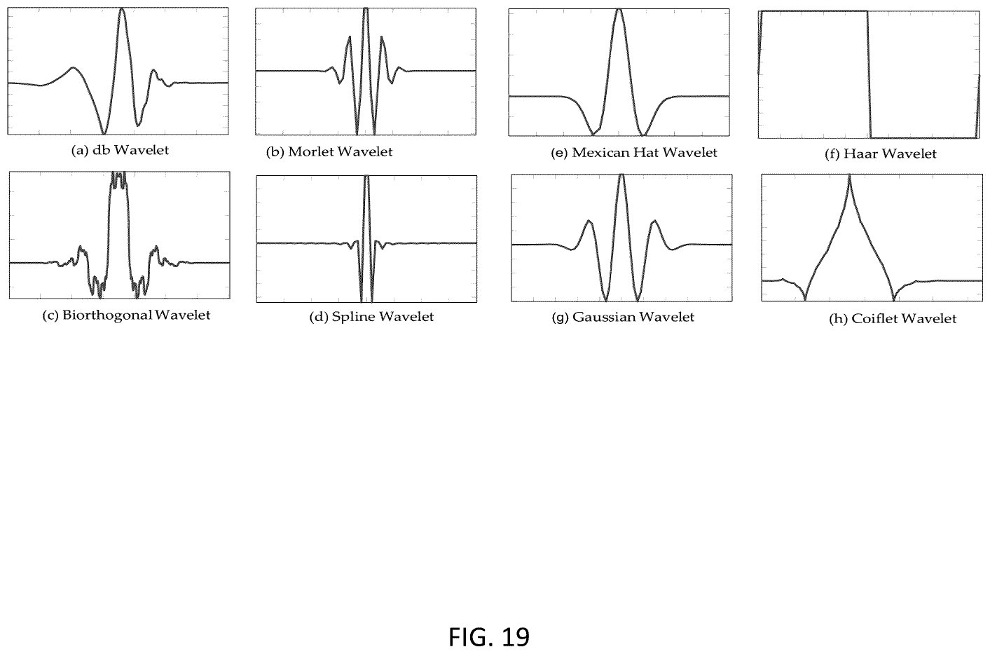

Conventional systems use the Fourier transform, which features only sine and cosine basis functions, whereas disclosed aspects provide for filtering properties that depend on the user defined mother wavelet, examples of which can be shown in FIG. 19 (Faust et al. (2015)). Disclosed aspects provide for a wider selection of basis functions, which gives the user more flexibility to target a specific problem.

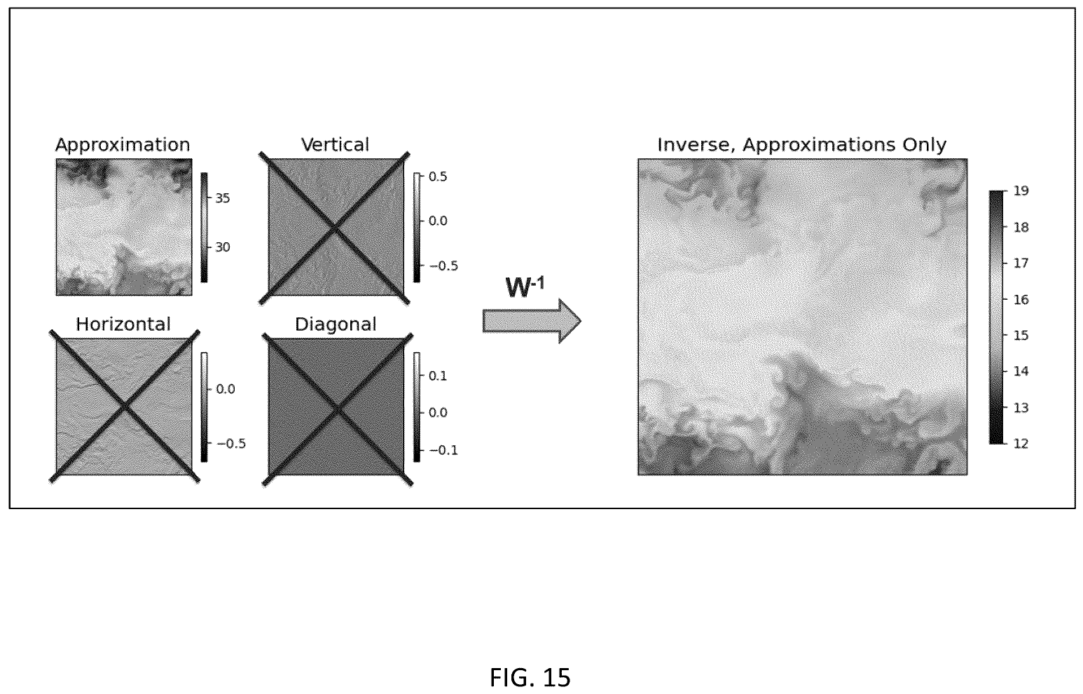

The wider selection of basis functions provided by disclosed embodiments gives the user more flexibility to target their specific problem. Disclosed embodiments use wavelets as a methodology by which to filter the observations more elegantly and effectively. Wavelets are basis functions that are convolved along a signal to decompose it into frequency and/or wavenumber space. There are a large set of potential basis functions that can be used, called mother wavelets (FIG. 19). According to some aspects, disclosed embodiments are compatible with all mother wavelets. The other parameter that can be tuned in disclosed embodiments is the number of levels of decomposition. Wavelets decompose a 2D signal by breaking it into four components: an approximation, horizontal details, vertical details, and diagonal details. These four sectors are illustrated in FIG. 15. The approximation is the low-pass representation of the original signal. The three detail components are different high-pass representations of the signal. The approximation can be further parsed by performing another level of decomposition. This second level of decomposition breaks the first level approximation into the second level approximation and details. This decomposition process can be repeated until the 2D grid can no longer be divided by two.

Disclosed embodiments can perform filtering by thresholding. Thresholding generally manipulates the details, of which there are many ways to do. Disclosed embodiments perform thresholding by removing all detail coefficients in the wavelets transform, leaving behind only the approximation at the final level of decomposition. This thresholding is performed in wavelet space and the wavelet inverse transform (W−1) is applied to the approximation at the final level of decomposition to return the filtered signal to 2D physical space. This process is illustrated in FIG. 15.

Per FIG. 14, disclosed embodiments filter the observations in wavelet space as a pre-processing step before NCODA. The level of decomposition, and thus the level of filtering, is a user input. The filtered observations in wavelet space (y′) are then passed to NCODA for assimilation. However, the observations decomposed into wavelet space cannot be compared with the model background to create an innovation unless that model background is also in wavelet space. Therefore, the model background (xb) is also brought into wavelet space, subject to the same mother wavelet, level of decomposition, and thresholding as the observations. The wavelet transformed ocean model background (xb′) can then be compared to the wavelet transformed observations to generate an innovation, also in wavelet space. Thus, a major modification to the larger NCODA system is that all pre-processing and assimilation is performed within wavelet space, as opposed to physical space. Comparing FIG. 13 and FIG. 14, one observes that the equations are modified primarily as a substitution of H, the observation operator, with the wavelet transform, W.

After an increment has been solved for in wavelet space, the inverse wavelet transform is performed to bring that increment field back to 2D physical space. That increment field is added to the ocean model background in physical space and that analysis is passed along to NCOM to produce an ocean forecast.

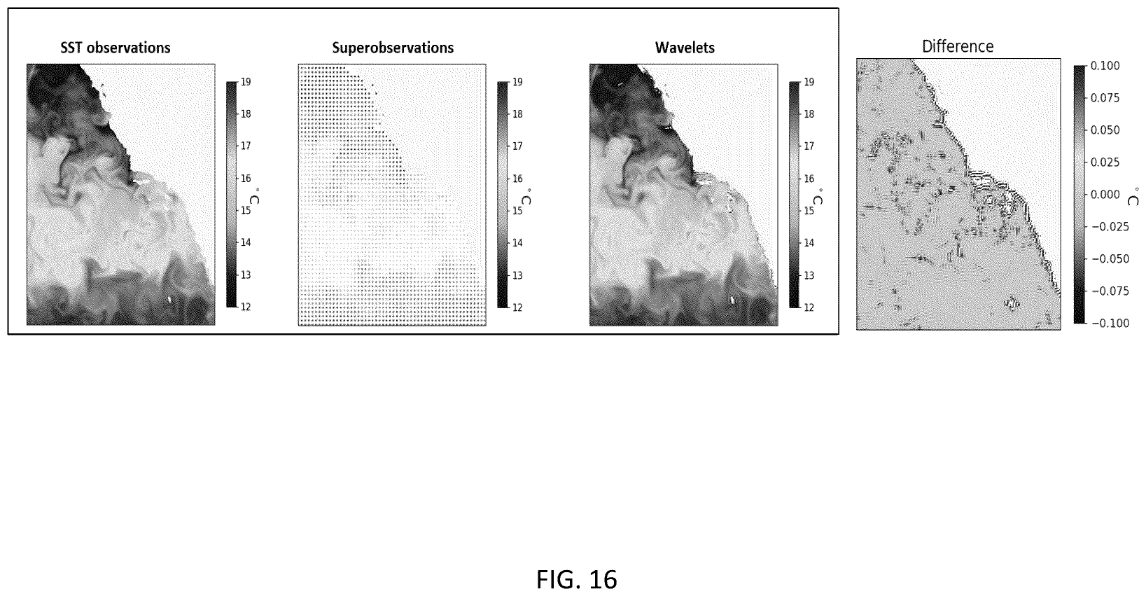

In ocean data assimilation, filtering of the observations is done to deal with observation redundancy within a decorrelation scale and to reduce observation error correlation. Unlike the conventional methods that use superobservations, disclosed embodiments retain more of the high-resolution information in the observations. This difference in observation pre-processing can be illustrated in FIG. 16.

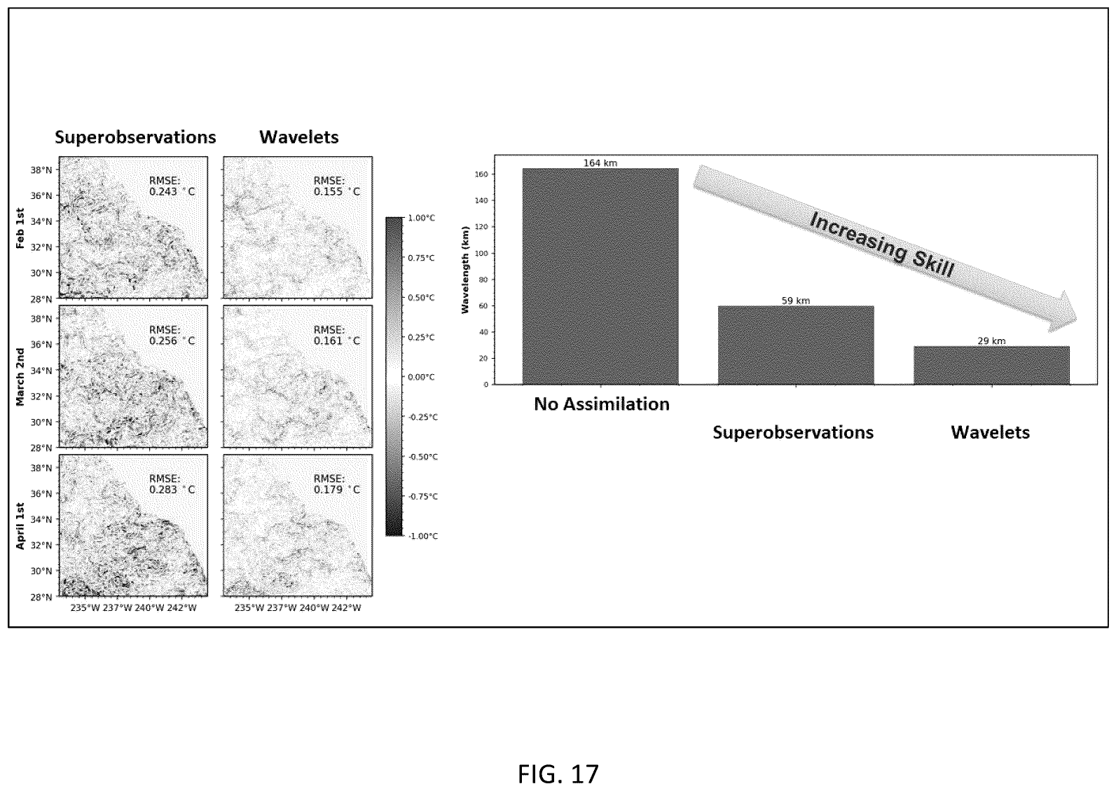

On the left-hand side set of FIG. 16, a very high-resolution (Δx=1 km) field of SST observations is presented. The middle panel (2^{nd} panel from the left) demonstrates the resulting field of superobservations. While general features in the original image are visible, it is clear that the observations have been filtered to a significant degree. The right most panel (third panel from the left) shows the wavelet filtering of the observations after thresholding three levels of decomposition and returning that approximation to 2D physical space. It is difficult to see a difference between the left most and right most (3^{rd} panel) plots using only the eye. Nonetheless, the right most plot (3^{rd} panel) has in fact been filtered to a level that still deals with observation redundancy and observation error correlation, without significantly distorting the original observation (the difference can be shown in the 4^{th} panel from the left). The results of assimilating each of the two fields (middle and right of the left set in FIG. 16) are illustrated in FIG. 17.

Experiments of cycling assimilation/forecasting using the conventional methods (superobservations) and the novel embodiments disclosed herein (wavelets) were performed over 6 months of simulation. The results consistently showed that disclosed embodiments outperformed the conventional methods. Two example statistics are shown in FIG. 17. On the left hand side, it is shown that SST errors in space at different days of simulation were consistently lower using the disclosed embodiments. Further, it was shown that disclosed embodiments allows NCODA to accurately predict SST spatial scales of 29 km and larger versus 59 km and larger for the conventional methods (right hand side of FIG. 17).

Overall, empirical evidence shows that disclosed embodiments significantly outperform the conventional methods with respect to errors in the analysis, while still providing for observation redundancy and observation error correlation.

### 2. Methods

### 2.1 Wavelet Background

Orthogonal transforms are a common process to glean maximal information from data. One of the most well-known orthogonal transforms is the Fourier transform, which uses sinusoidal basis functions to decompose signals into time and/or space components. The wavelet transform is a similar concept, except the basis functions are finite pulses in space (or time) called wavelets. This different form of basis functions allows for a more balanced frequency and spatial (or temporal) resolution. The Fourier transform assumes a signal is stationary: that its stochastic properties are constant over the domain. This gives great frequency information, but the specific spatial information where these frequencies occur in the signal is lost. Methods such as the Short Time Fourier Transform (STFT) may be used to overcome this loss of spatial localization with varying degrees of success. The wavelet transform on the other hand is designed to work with non-stationary signals, specializing in both frequency and spatial (or temporal) localization (Rhif, et al. 2019).

Wavelets are related to the Fourier transform. The Fourier transform is a mathematical operation that may reveal the frequency content of a signal. The continuous case is given by:

$$X ( f ) = {\int }_{- ∞}^{∞} x ( t ) {e}^{- i 2 π ft} dt$$

The Wavelet Transform is similar to this, but with a different basis. For example, the continuous wavelet transform is given by:

$$( a , b ) = {\int }_{- ∞}^{∞} x ( t ) W ( \frac{t - b}{a} ) dt$$

According to some aspects, the Wavelet Transform gives a good time and frequency resolution, where Fourier gives the extremes of either.

The discrete case is given by convolution with low-pass (h) and high-pass (g) filters of particular discrete wavelet families. This leads to the output called approximations and details.

### Approximations:

$$( {\sum }_{i = - ∞}^{∞} x ( i ) h ( n - i ) ) ( ↓ 2 ) ; Details : ( {\sum }_{i = - ∞}^{∞} x ( i ) g ( n - i ) ) ( ↓ 2 )$$

For the 2D case, as would be done for SST fields, the process is applied on the columns and then on the rows yielding a matrix of coefficients.

Regarding wavelet thresholding, once the wavelet transform is applied, we may remove certain coefficients to effectively “filter” our input signal. So that when the inverse wavelet transform is applied we have an altered signal.

There are many choices for the wavelet basis functions. In some cases, these are called mother wavelets, some of which are illustrated in FIG. 19. For the continuous wavelet transform, the mother wavelet is scaled and shifted then convolved with the signal. This creates corresponding wavelet coefficients at different scales and shifts. However, since our observational and model data are discrete, we may use the discrete wavelet transform. The equation for the one-dimensional (1D) discrete wavelet transform is given by Eq. 1:

$${φ}_{A} = {D}_{2} [ ( s * h ) ] \\ {φ}_{D} = {D}_{2} [ ( s * g ) ] \\ {φ}_{wcoef} = [ {φ}_{A} {φ}_{D} ]$$

where s represents the input data, h and g are low- and high-pass filter coefficients, respectively, “*” indicates convolution, and D₂ indicates downsample by two. Downsampling by n removes every nth term in the signal and is best understood with an example:

$${D}_{2} [ {s}_{1} {s}_{2} {s}_{3} {s}_{4} {s}_{5} {s}_{6} {s}_{7} ] = [ {s}_{1} {s}_{3} {s}_{5} {s}_{7} ]$$

where downsampling by n takes a signal of length m and reduces it to length

$$length ∼ [ \frac{m}{n} ] .$$

The filters h and g in Eq. 1 correspond to a mother wavelet from a chosen discrete wavelet family, such as Daubechies, symlets, coiflets, or biorthogonal (Strang 1996; Daubechies 1992). Wavelet filters are designed in such a way that the low-pass and high-pass encompass the whole spectrum of the input signal, with minimal overlap (Valens 1999). Thus, φ_{A} is the output of the lowpass, called the approximation, containing wavelet coefficients corresponding to lower frequency terms and, likewise, φ_{D}, called the details, contains wavelet coefficients corresponding to the higher frequencies. The approximation and detail coefficients are each half the length of the original input signal length due to the downsampling (by 2) operator. The output of the wavelet transform (φ_{wcoef}) is a concatenation of the approximation and detail coefficients, together now equaling in length to the original input data length. Specifically, Eq. 1 is the result of one “level” of wavelet transform. To calculate another level of the transform, Eq. 1 is applied again, but with input s equal to the φ_{A} of the previous level of transform only. This will further split the lowest frequencies into new approximation coefficients and defers the “highest of the lowest” frequencies to the second level details leaving an output:

$${φ}_{wcoef} = [ {φ}_{lvl 2 , A} , {φ}_{lvl 2 , D} , {φ}_{lvl 1 , D} ]$$

where φ_{lvl1,D} is PD in Eq. 1, still half the length of the input signal and the level two coefficients, specified with “lvl2” were computed from φ_{A}, now each a fourth of the length of the input signal. At each level of wavelet transform of the signal can be thought of as being placed into more and more dyadic bins that cohesively attempt to cover the entire spectrum of the original input signal. The simplest wavelet family is called the Haar and it has filter coefficients:

$$h = [ \frac{1}{\sqrt{2}} , \frac{1}{\sqrt{2}} ] g = [ \frac{1}{\sqrt{2}} , \frac{- 1}{\sqrt{2}} ]$$

The low-pass filter coefficients (h) of the Haar wavelet perform a simple moving average on the signal, whereas the high-pass (g) are finite differences. A 1D wavelet transform with the Haar wavelet will give approximation wavelet coefficients that represent averages of the signal, and the details gives the differences, which is a very useful tool for edge detection. At a base level, all wavelet families operate under this framework of averages and finite differences, but with more complex wavelet shapes to represent a variety of signals.

Note that due to the discrete convolutions involved in taking the discrete wavelet transform, edge effects will occur in the output. These edge effects will increase with the levels of transform due to the increased number of convolutions performed. There are a variety of ways to minimize this effect. One such way is the choice of signal extension when performing the convolution, such as assuming the signal repeats to the left and right of itself (periodic extension). This is the method we employ in disclosed embodiments. We keep only the region of the convolution in which the original signal overlaps itself to yield an output of the same length. If we allow some degree of the periodic overlap, the edge effects typically reduce further, but the output will be longer in length. However, the levels at which the edge effects cause considerable problems are often not needed as one would be approaching the smallest bins of frequency. When working with data sets like SST, which may contain large land masses and/or clouds, it is important to carefully select the level of transform. These large land masses and clouds are treated as edges in the data.

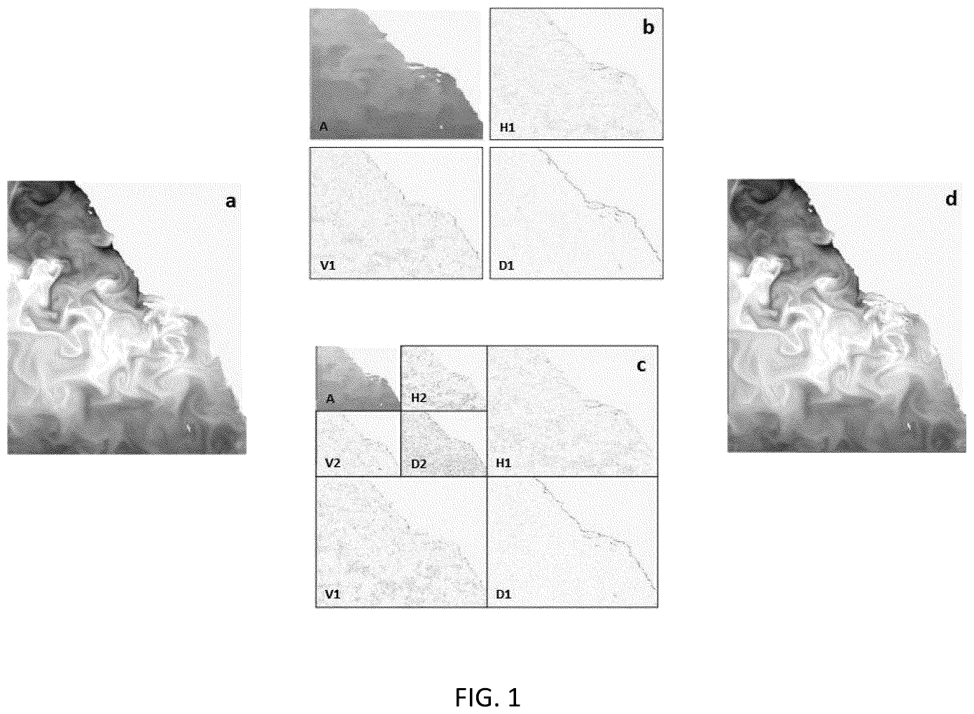

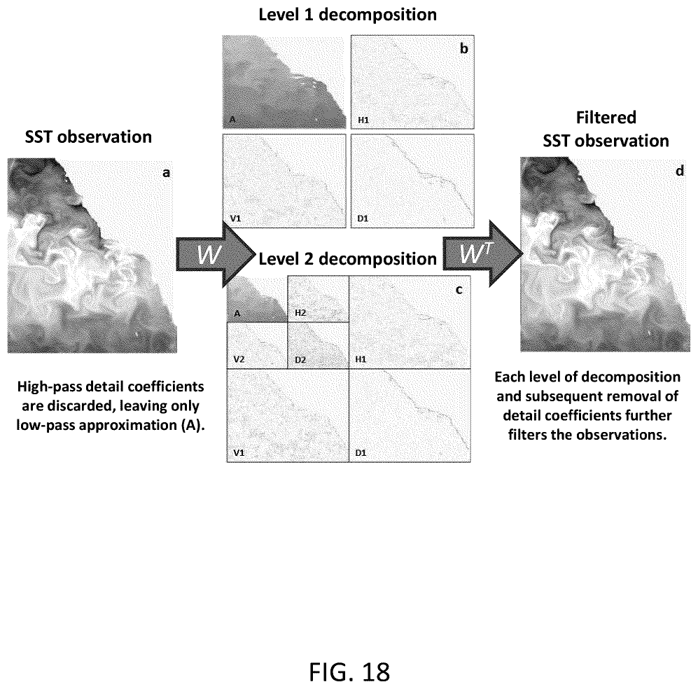

FIGS. 1 and 18 illustrate an example schematic of a wavelet-based decomposition process, in accordance with one or more disclosed aspects. According to disclosed embodiments, disclosed embodiments concern two-dimensional (2D) fields of SST maps, which require a 2D discrete wavelet transform. To modify Eq. 1 for the 2D case, it is simply applied on all the rows of the 2D field treating each row as 1D input. Then Eq. 1 is performed on the columns of the previous output. FIG. 1b shows an example of taking the 2D wavelet transform of FIG. 1a. After one level of transform there are four distinct quadrants in the output as seen in FIG. 1b, which are named: approximation (A), horizontal details (H1), vertical details (V1), and diagonal details (D1), not to be confused with model grid directions. The approximation gets its name from the fact that the data confined in this region is the output of a low-pass across the rows and a low-pass across the columns; the approximation consists of the lowest frequency terms in the data. For an image, low frequency terms are ones that change very slowly over the pixels, thus are the largest scale components of the image, which ends up being an “approximation” of the initial input image. The three detail quadrants get their respective names from how the high-pass goes over the rows (vertical), the columns (horizontal), or both (diagonal) preferentially selecting the pixels that change very quickly from one to the next. This gives all the vertically, horizontally, or diagonally shaped “pieces” of the image in these quadrants. Taking another level of transform in the 2D case is the same as it is for the 1D, take the approximation coefficients from the first level output and apply the transform again. The approximation coefficients now cover a lesser range of the frequency axis, as they have been “given” to the level two detail coefficients. This is shown in FIG. 1 (as well as FIG. 18), as going from FIG. 1b to 1c. The H1, V1, and D1 detail coefficients are the same in FIG. 1c as they were in FIG. 1b.

Once the transform is acquired, it may be altered by thresholding the wavelet coefficients. There are two common methods to perform wavelet thresholding: soft and hard. Soft is a modulation of coefficients in which values are linearly reduced towards zero when their absolute value is below a certain threshold. Hard sets any coefficient with absolute value below the threshold to zero. Hard thresholding is great at preserving edges while soft thresholding provides smoother results (Jansen 2001). The implemented method in this study consists of hard thresholding each of the three detail regions of the 2D transform to zero, removing them completely.

To return the wavelet coefficients to the spatial domain, an inverse wavelet transform is required. Since the wavelet transform is an orthogonal operator, the inverse wavelet transform is simply the transpose process of the forward wavelet transform shown in Eq. 1. The coefficients are first upsampled by two and then convolved with low- and high-pass reconstruction filter coefficients. For orthogonal filter banks (Haar, Daubechies, symlets, coiflets) the reconstruction filter coefficients are completely defined by the decomposition filter coefficients. Further, the high-pass decomposition filter is defined by an alternating flip of the low-pass decomposition filter coefficients, as seen in equation 16 in (Winkler 2000), thus only the low-pass decomposition filter coefficients are required to be stored. FIG. 1d shows an example of the inverse wavelet transform after thresholding all the detail coefficients. Excluding the slight edge effects along the landmass, the inverse appears almost identical to the input image FIG. 1a. As noted in the 1D case, each level has the effect of halving the approximation and detail coefficients length. So, if a 2D input to the 2D wavelet transform has dimensions N×M, then each region of the wavelet coefficients is reduced in size to

$$\frac{NM}{{4}^{L}}$$

according to wavelet level (L). Keeping only the approximation coefficients thus reduces computational storage size of the image by

$$\frac{1}{{4}^{L}} .$$

For a level 2 transform, this is a 94% reduction with minimal loss in image quality on the inverse.

### 2.2 3DVAR and Super Observations

We consider the problem of minimizing the following cost function Eq. 2:

$$J ( x ) = {( x - {x}_{b} )}^{T} {B}^{- 1} ( x - {x}_{b} ) + {( y - Hx )}^{T} {R}^{- 1} ( y - Hx )$$

where x is the three-dimensional state variable, x_{b} is a prior state forecast (background) from a given model, y is the set or vector of observations of the state, H is the observation operator mapping the state to the observations space, B and R are the background and observations error covariances, respectively. Eq. 2 is a weighted cost function in which the weights are the inverses of the respective model and observation error covariances. The 3DVAR method finds the minimum of the cost function using the variational principle, a solution that is also called the analysis (xₐ), and is given by Eq. 3:

$${x}_{a} = {x}_{b} + {{BH}^{T} ( {HBH}^{T} + R )}^{- 1} ( y - {Hx}_{b} )$$

where the term (y−Hx_{b}) is called the innovation (sometimes called the correction or correction value or factor) and the term BH^{T}(HBH^{T}+R)⁻¹(y−Hx_{b}) is called the increment.

For any 3DVAR scheme, assumptions about the structure of B and R are crucial. Often, the nature of the true errors of the system is not known, thus this requires assumptions on the formulations of the error covariances. Once the structure of the error covariances is set, the next consideration is the mathematical method by which the matrix inversion in Eq. 3 is solved. Inversions are often costly to implement for large unstructured matrices, which gives further credence to the careful choice of B and R. We used a conjugate gradient method to solve the inversion in Eq. 3, because all matrices involved are symmetric and positive definite. In the conjugate gradient method, the number of iterations depends upon the condition number of the matrix Eq. 4:

$$A = {HBH}^{T} + R$$

The more A is kept diagonally dominant, the better its condition number (S. A. Haben 2009). A common assumption for 3DVAR is that the observations are uncorrelated, which leads to R being diagonal. These leaves HBH^{T} in Eq. 4 being the only term that will alter the condition number. It may contain significant off-diagonal terms if the local correlation scales in B are larger than the distances between potentially correlated observations.

To enforce a diagonally dominant A for correlated observations, one may either thin the data and/or compute superobs. The way that this works for SST observations in NCODA is to pre-process the observations into superobs (Cummings 2005). The observations are averaged together based upon the correlation length scale of the background error covariance, which, in NCODA, is the local Rossby radius of deformation; we will henceforth refer to this horizontal correlation scale as the Rossby scale. This leaves a very sparse, potentially irreversible signal that only represents the lowest frequencies which correspond to only the largest scale terms. For superobs, the observation operator (H) is a matrix of size (Nₛ×NM), where N_{S} is the number of prepared superobs and N, M is the latitudinal and longitudinal dimensions of the model grid, respectively. In this matrix are values of ones where superobs are located on the model grid and zero elsewhere. This matrix will act on state variables of size (NM×1). The observation operator (H) is a constant for each pre-processed observation with collocated model locations. The transpose of the observation operator (H^{T}) then brings superob locations to model grid (state) space.

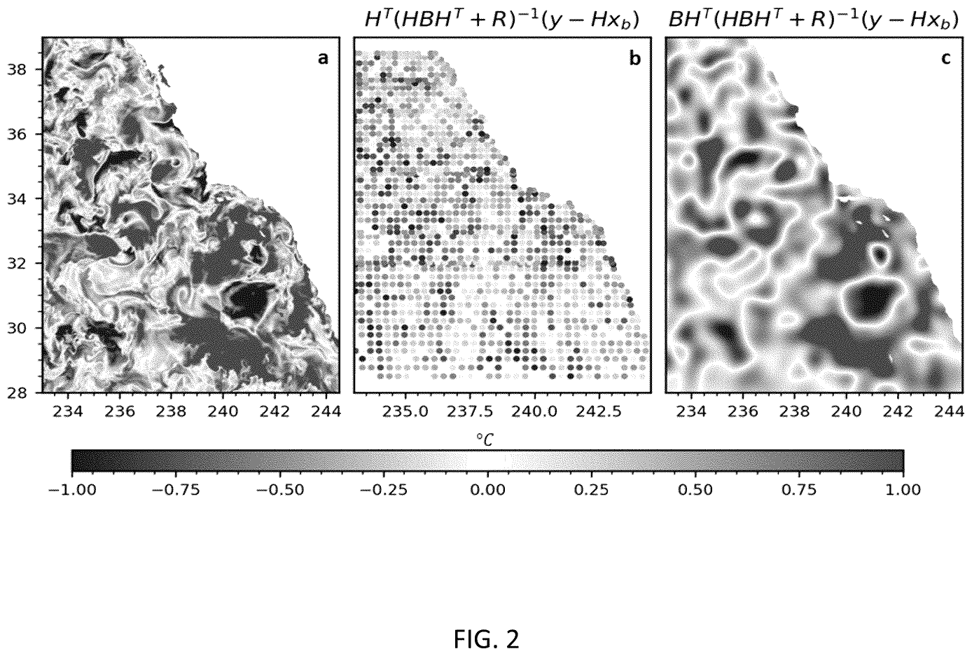

There are two potential related issues with superobs: the selection of the correlation scales and the resulting reduction of observational information. The issues are addressed in NCODA by choosing Rossby scale as the correlation length scale, which is based on precedence. In the past, ocean observations did not contain enough information to resolve features below the Rossby radius, so anything near or below these scales were considered noise. This notion is changing quickly as more observational systems can resolve sub-mesoscale features. However, to this day, making superobs to the Rossby scale is still the operational standard in NCODA. The superob process reduces the observation information to a sparse field of averaged points that are used to correct the model at their respective locations before the post-multiplication (BH^{T}) spreads this information spatially. FIGS. 2b and 2c shows the increment field on the model grid before and after multiplication by (B).

To facilitate a comparison to operational standards, the superobs were generated from NCODA by using the full-field sampled NATURE run SST at 00z of each day (see section 2.4). NCODA read in these observations as if they were Visible Infrared Imaging Radiometer Suite (VIIRS) observations. The observation error variance for the simulated SST observations was assigned a constant 0.41° C.², as they would be for real VIIRS observations.

For the background error covariance, we used a Gaussian operator constructed according to Eq. 5 below:

$$B ( i , j ) = {σ}_{s}^{2} {e}^{- \frac{{r ( i , j )}^{2}}{2 {C ( i , j )}^{2}}}$$

Where r is the distance between two model grid indices, i and j,

$${σ}_{s}^{2}$$

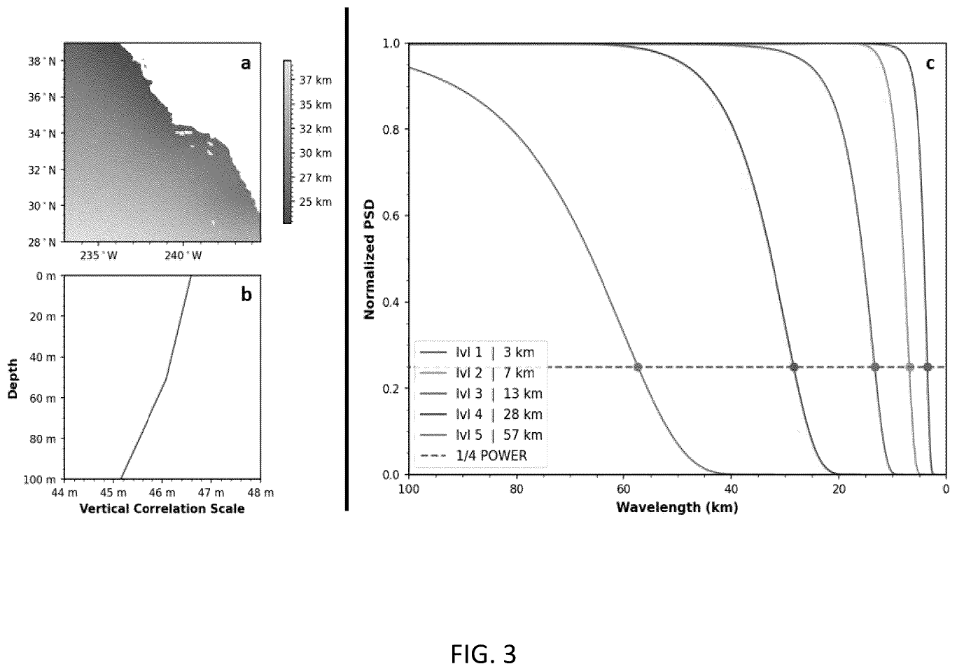

is the background error variance assigned to the superobs and C is the Rossby scale from NCODA, which varies in space (FIG. 3a). We chose a constant 1° C.² background error variance for the experiments. These settings for both B and R were used for the experiments in the aspects described herein, with some changes to the background error variance for B as discussed in the next section.

### 2.3 Wavelet-3DVAR

To formulate Wavelet-3DVAR, we pre-process our observations in wavelet space Eq. 6:

$${y}^{′} = Wy$$

where W is the wavelet forward transform operator and the prime (′) indicates a variable in wavelet space, i.e., transformed into wavelet coefficients. This then requires the model background to also be brought into wavelet space. This makes the wavelet transform act as the observation operator. From section 2.1, the inverse transform W⁻¹ for a chosen orthogonal mother wavelet is simply the transpose W⁻¹=W^{T}. Eq. 2 can be rewritten now as Eq. 7:

$${x}_{a} = {x}_{b} + {{BW}^{T} ( {WBW}^{T} + R )}^{- 1} ( {y}^{′} - {Wx}_{b} )$$

W and W^{T} are now referred to as the wavelet observation operator. In a mathematical formulation, the wavelet observation operator has dimensions (N_{w}×NM) where N_{w} is the number of the retained approximation wavelet coefficients which from section 2.1 would be of size

$$\frac{NM}{{4}^{L}} .$$

Like superobs, it acts on state vectors of size (NM×1). To yield an innovation in wavelet-3DVAR observations are first pre-processed by being collocated on the model grid, through interpolation or other such methods. This is due to framing the transform as a two-dimensional operator acting on a vectorized two-dimensional “image” of the observations on the model grid. Masked values are set to 0 and then the collocated observations are wavelet transformed to a desired level, keeping only the approximation coefficients, these are now the observations used in the assimilation (y′ in Eq. 7). The model background is similarly brought to wavelet space at the same level of decomposition and retention of approximation coefficients. The innovation is calculated from the difference of the wavelet coefficients from the pre-processed observation and background.

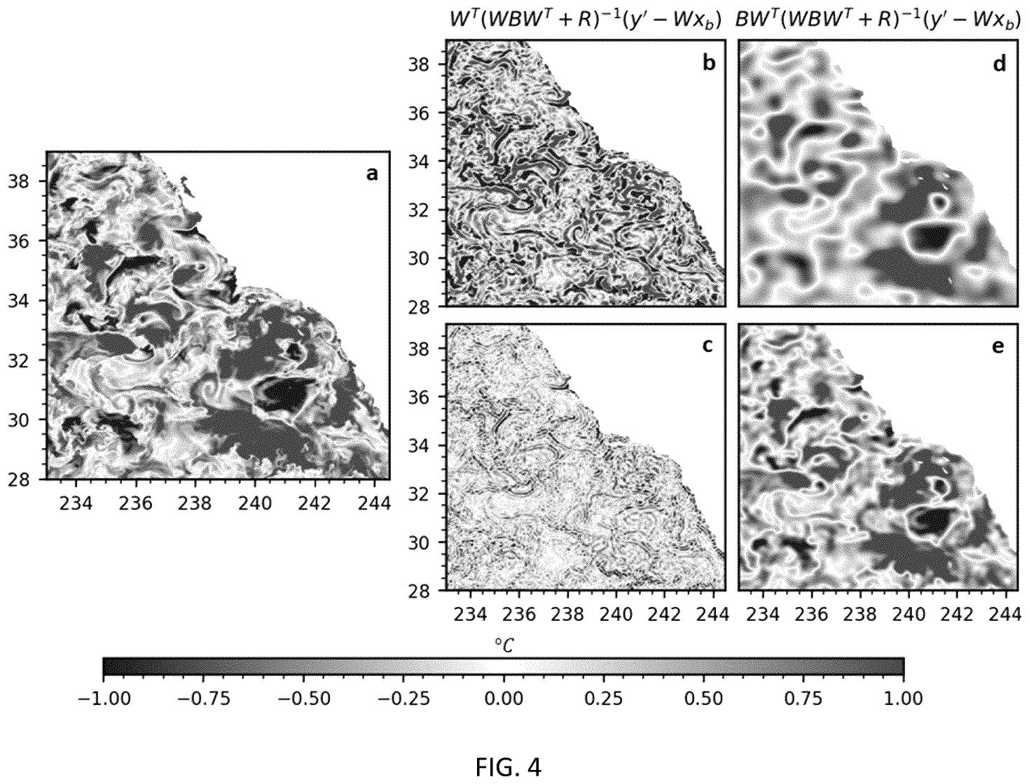

The mother wavelet and the level of transform are the controls that primarily affect the wavelet-3DVAR method. Choice of mother wavelet determines the effectiveness of the transform on the signal. A rule-of-thumb is that the more the mother wavelet has similar features as the signal, the better the outcome. The level of transform determines how many frequency bins are available to alter, but the higher the level, the more edge effects errors are provided. The level and choice of wavelet determine what scale the observations are filtered to, and this scale will be called wavelet scale, as opposed to Rossby scale. One of the key differences for wavelet-3DVAR from superobs, is that the transpose wavelet observation operator returns filtered observational information to the original observation model grid locations, whereas the superobs transpose observation operator only returns to superob locations and is then spatially spread by the action of the background error covariance operator. Wavelet-3DVAR is also acted on by the background error covariance operator, but this only smooths the field. Mathematically, since smoothing operators are low-pass filters, this would be the second cumulative filtering operation after the transpose wavelet observation operator acts. If the length scales of the background covariance operator are larger than the wavelet scale, then no new information should be removed by the low-pass filtering done by the background covariance operator. However, this action does handicap the wavelet observation operator. If wavelet scale is much smaller than Rossby scale for instance, but the error covariance is applied at Rossby scale, then the wavelets lose most of the extra observational information it contained in-between wavelet and Rossby scale. Similar to section 2.2 and FIG. 2, FIGS. 4b and 4c shows the increment on the model grid before applying (B), with the covariance length scale set to Rossby and wavelet scale respectably. This clearly shows a more spatially dense field with observational information at all model grid points. FIG. 4d shows the effects of post-multiplication at Rossby scale and FIG. 4e is post multiplication at wavelet scale. The goal is to show that the wavelet transform is a better observational operator than superobs due to the increased observational information retained from the original observation at all grid points, especially of the smaller scale. We hypothesize that if wavelet-3DVAR has similar performance as superob given the same settings (correlation scales and equivalent error variances), then wavelet-3DVAR with inherent wavelet scales will perform better than superobs with Rossby scales.

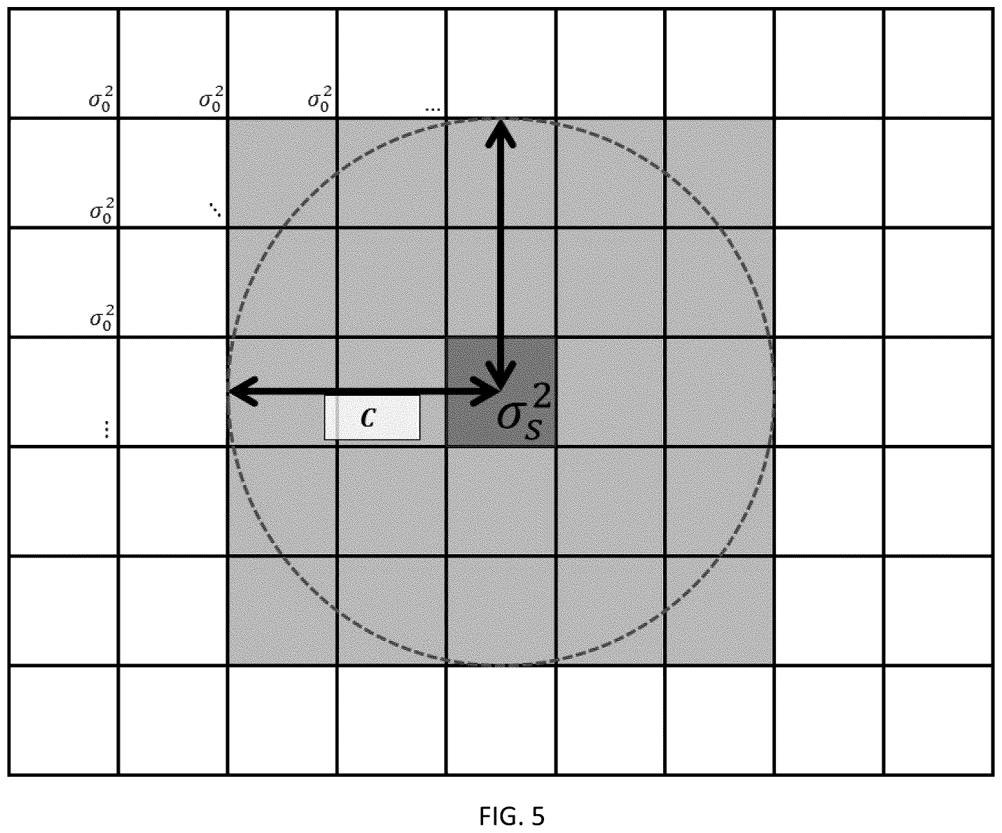

The derivation of the analysis for wavelet-3DVAR is similar to the superob method in which the inversion in Eq. 7 is achieved with a conjugate gradient method. However, for wavelet-3DVAR the main differences are 1) the wavelet observation operator and 2) a modified background error variance. The modification of the variance arises from considerations visualized in FIG. 5, which illustrates the calculation of a superob and its location on the model grid. This superob is calculated by averaging all observations within a correlation scale (C), the footprint of which is shown as the circular red dashed line in FIG. 5. However, in NCODA, the discretized nature of the grid causes the footprint to be the square of the correlation scale shown by the blue shaded region. Theoretically, the model grid holds a per grid background error variance of (σ₀²). Thus, when assigning the background error variance to superobs (σₛ²), it may be calculated by summing the per grid variance, due to error propagation rules, as Eq. 9:

$${σ}_{s}^{2} = \sum {σ}_{0}^{2} = {C}_{a v g}^{2} {σ}_{0}^{2}$$

where (C_{avg}) represents the average Rossby scale. Now, since the wavelet observation operator returns to the model at every grid point, the background error variance for the wavelet method may then be the per model grid point value. So, for the comparison of the methods the variance assigned to superobs may be modified for wavelets by Eq. 10:

$${σ}_{w}^{2} = {σ}_{0}^{2} = \frac{1}{{C}_{a v g}^{2}} {σ}_{s}^{2}$$

All the above also holds for the wavelet-3DVAR experiment at wavelet scale, although with the background error covariance length scales now set to wavelet scale.

Preliminary testing showed that using Daubechies 4 (DB4) wavelets as W in Eq. 7 yielded favorable results and would serve as a good starting point. The filter coefficients for this discrete wavelet family were obtained from (Wasilewski)(https://wavelets.pybytes.com/) The filtering goal by using wavelet transform was two-pronged: one is to remove model noise, ˜10 km in our 1 km NCOM run (Roache 1998), and the second is to decorrelate observational errors comparable to superobs. To determine a sufficient level of wavelet transform, the frequency response of the low-pass filter may be examined. Looking back at Eq. 1 and manipulating for multiple levels gives Eq. 10:

$${φ}_{A} = {φ}_{1} = {D}_{2} [ ( s * h ) ]$$

$${φ}_{L} = {D}_{2} [ … {D}_{2} [ {D}_{2} [ ( s * h ) ] * h ] … * h ] = {D}_{2} [ {D}_{2 ( L - 1 )} [ s ] * {h}_{L} ]$$

$${h}_{L} = {D}_{2 ( L - 1 )} [ h ] * {D}_{2 ( L - 2 )} [ h ] … * h$$

$$ex . ) {h}_{3} = {D}_{4} [ h ] * {D}_{2} [ h ] * h$$

where φ_{L} is the output of the approximation coefficients at level L (shown for L≥3), and h_{L} is the filter coefficients at level L. Recall that “*” indicates convolution. Taking the Fourier transform of h_{L} gives the frequency response of this filter. FIG. 3c shows plots of the frequency response for different levels using the DB4 wavelet. Ultimately, three levels of transform were chosen for all wavelet-3DVAR experiments based on: the cutoff wavelength of ˜13 km, defined as the ¼ power reduction in the Power Spectral Density (PSD), being near the model noise value of ˜10 km, removing enough potentially correlated small-scale observational error, and low enough level to reduce significant edge effect errors primarily near the coastlines. This means that the wavelet scale was set to a constant 13 km everywhere, as opposed to the varying Rossby scale as shown in FIG. 3a.

### 2.4 Experimental Setup and Model Specification

We compare the superobs method and wavelet-3DVAR using an identical twin data assimilation experiment. First, a NATURE run was generated and is considered the true state of the system. Since the true state of the system is known through the NATURE run, exact error metrics of each assimilation experiment may be calculated.

For the experiments described, the Navy Coastal Ocean Model (NCOM) (Martin 2000; Barron, et al. 2002) is used with 1 km horizontal grid and 100 vertical hybrid sigma-z layers. The NATURE run is generated using NCOM and NCODA-3DVAR data assimilation of real ocean observations from in situ Argo profiles, satellite SST, and sea surface height from nadir altimeters (D'Addezio and Jacobs 2022). Atmospheric surface forcing was provided by a NAVY Global Environment Model (NAVGEM) (Hogan et al., 2014) simulation, and is the same forcing used in all the experiments. Initial and lateral boundary conditions supplied by a double nesting procedure. First, the global 1/12° HYbrid Coordinate Ocean Model (Chassignet, et al. 2007) provided the initial and lateral boundary conditions to a 3 km NCOM simulation, then the 3 km NCOM solution provided the initial and lateral boundary conditions for the final 1 km nest used as our NATURE run. The initial conditions for all the assimilation experiments were generated by taking the NATURE run state on Dec. 1, 2019, and providing that to NCOM as an initial condition on Dec. 1, 2018. That initial state was then integrated in time, without data assimilation, to Dec. 31, 2018. The 24-hour forecast state on Dec. 31, 2018, was then used as the initial condition for the assimilation beginning on Jan. 1, 2019. This background state on Jan. 1, 2019, is not equal to the NATURE run state on the same date but is seasonally similar enough such that any assimilative effort should bring it to the NATURE run without having to deal with large biases that might result from using a significantly out of season initial state.

SST observations were sampled from the NATURE run on its native 1 km grid every 00z. Four six-month long assimilation experiments were carried out, cycling analysis and forecast on a daily basis: The first experiment used superobs (as in section 2.2) with traditional 3DVAR, Gaussian background correlation operator, background error variance of 1° C.², and a diagonal observation error covariance with a variance of 0.41° C.². The second assimilation experiment, referred to as wavelet-RS for wavelet at Rossby scale, used wavelet-3DVAR with the same settings as superobs above but with the wavelet observation operator and modified background error variance as described in section 2.3. The third assimilation experiment referred to as wavelet-WS for wavelet at wavelet scale, was similar to the wavelet-RS experiment, with the exception that the background error covariance used the wavelet scale, instead of the Rossby scale. The last experiment referred to as wavelet-clouds was the same as the third, but we simulated clouds in the observations using Perlin noise (Lagae, et al. 2010). This was done to show the capability of the wavelet observation operator in a slightly more realistic scenario in which the observation map is irregularly obscured, a common scenario for real SST observations. A non-assimilative free run of the model was provided as a baseline.

SST is correlated with subsurface temperature, particularly within the mixed layer. We applied a vertical Gaussian correlation to the SST increment, to obtain a full three-dimensional temperature increment with a focus on the near surface. This vertical gaussian operator differs from Eq. 5 by using vertical correlation scales from NCODA, shown in FIG. 3b. All the experiments will be evaluated using metrics outlined in the next section.

### 2.5 Error Metrics

Several metrics are used in order to compare the superobs and wavelet-3DVAR results. Since the true state is known, the exact error fields may be calculated as Eq. 11:

$$ε ( i , j , z , t ) = NATURE ( i , j , z , t ) - {x}_{a} ( i , j , z , t )$$

where ε is the error at grid point i,j, z and time t. This error shows the features that are missing or erroneous in the assimilation. Root mean square error (RMSE) is used to analyze the ability of the experiment to correct the surface and subsurface. The temporal surface RMSE is calculated with Eq. 12:

$$RMSE ( t ) = \frac{{\sum }_{i = 1}^{N} {\sum }_{j = 1}^{M} {( ε ( i , j , 0 , t ) )}^{2}}{NM}$$

where N, M is the longitudinal and latitudinal dimensions, respectively, i and j are the longitudinal and latitudinal grid indices, respectively, and t is the temporal index. The depth RMSE over the whole run is then calculated using Eq. 13:

$$RMSE ( z ) = \sqrt{\frac{{\sum }_{t = 1}^{T} {\sum }_{i = 1}^{N} {\sum }_{j = 1}^{M} {( ε ( i , j , z , t ) )}^{2}}{NMT}}$$

where T is the total number of days and z is the depth index. Since the focus of this study is to assimilate more small-scale information available in the SST observations, the wavenumber power spectral density (PSD) of the signals is leveraged Eq. 14:

$$PSD ( k ) = {\vert S ( k ) \vert}^{2}$$

where S(k) is the Fourier transform of signal s(n). k is the discrete wavenumber spectrum and runs from zero to Nyquist for real signals, which for a 1 km grid is

$$( \frac{1}{2 km} ) ,$$

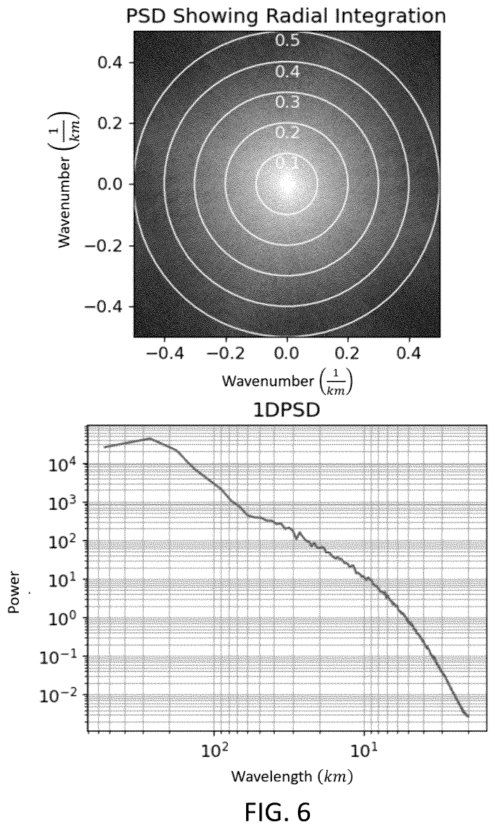

and has length K. n is the discrete index for the signal and can represent time or spatial coordinates. We utilized the latter (spatial coordinates) and it has length Nₛ. The PSD is used to determine the horizontal scales in the signal that have the most power. Signals used here are 2D in nature which prompts the use of 2D PSDs. For all 2D PSDs described, the signals were pre-processed in the following ways: First, a subregion consisting of the largest square in the model domain that did not contain land was selected for computing the PSDs. Second, the mean was subtracted from the signal in the subregion to remove the 0 k value. Lastly, a Tukey window (Roy and Morshed 2013) of 10% was applied to bleed out the edges, enforcing the infinite cyclical boundary conditions of the Fourier Transform (Richman, et al. 2012). 2D PSDs are difficult to interpret, thus, the time mean 2D PSDs were radially averaged to reduce it to a 1D PSD (FIG. 6). Starting from the (0,0) k value at the center of the 2D PSD, all terms that fell in the range [(0,0)−(dk, dk)] were averaged together and placed at dk on the 1D PSD. This continued with the next being in the range [(dk, dk)−(2dk, 2dk)] and so on until the Nyquist wavenumber was reached.

To quantify skill in the data assimilation experiments, and following D'Addezio, Smith, et al. (2019), we normalized the 1D PSDs of the analyses of each experiment according to Eq. 15:

$$\frac{{E}_{EPT}}{〈 {γ}_{NATURE} , {γ}_{EPT} 〉}$$

where E_{EPT} is the error 1D PSD of Eq. 11 for each experiment, Y_{NATURE} and Y_{EPT} are 1D PSDs of NATURE run and experiment respectively, and < > indicates an average. By taking advantage of Parseval's theorem (Eq. 16) and the fact that the mean was removed when calculating the PSDs, this allows Eq. 15 to be equated to the variance of the signal yielding Eq. 17:

$${\sum }_{n} s ( n ) = \frac{1}{K} {\sum }_{k} S ( k ) \qquad Eq . 16$$

$$2 ( \frac{var ( NATURE ) + var ( EPT ) - 2 cov ( NATURE , EPT )}{var ( NATURE ) + var ( EPT )} \qquad Eq . 17$$

Eq. 17 demonstrates the limits of what Eq. 15 will yield depending on how correlated (or uncorrelated) the experiment is from the NATURE run. For example, if they are 100% correlated (no errors), Eq. 15 gives the value 0, and if they are completely uncorrelated (maximum error), Eq. 15 gives the value 2. As was done in (D'Addezio, Smith, et al. 2019) we take the point at which the output of Eq. 15 crosses 1.0 to mean all scales below are considered constrained by the assimilation and all scales above are considered unconstrained by the assimilation. Further, by integrating the numerator and denominator of Eq. 15 across all wavelengths, and then dividing we yield a numerical value that considers the overall error across all scales. The lower this number, the better the experiment performed on average across all scales.

### 3. Results

### 3.1 Rossby Scale Comparison

As discussed in section 2.4, the superob experiment was run with 3DVAR using pre-processed superobs generated by NCODA for calculating the innovation, used a Gaussian background error covariance with a length scale of Rossby scale (˜30 km) (FIG. 3a), and a variance of 1° C.². The observations error covariance was assumed diagonal matrix with a variance of 0.41° C.². The wavelet-3DVAR experiment, wavelet-RS, was run with 3DVAR using pre-processed wavelet coefficients to three levels of decomposition keeping only the approximation coefficients for calculating the innovation. It used the same Gaussian background error covariance as the superobs experiment, but with a modification of the variance according to Eq. 9. The background error covariance length scale and observational error covariance were the exact same as superobs. The surface correction was spread to the near surface with a Gaussian operator with length scale shown in FIG. 3b. The Free run (no assimilation) served as a baseline in the comparison.

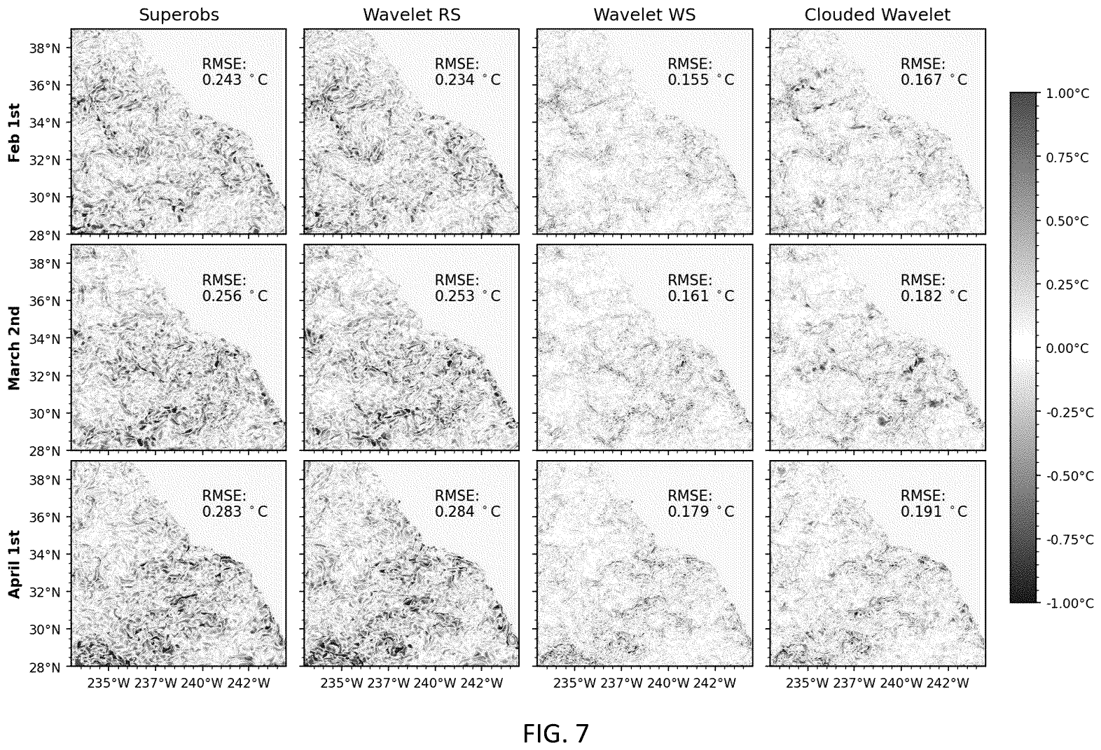

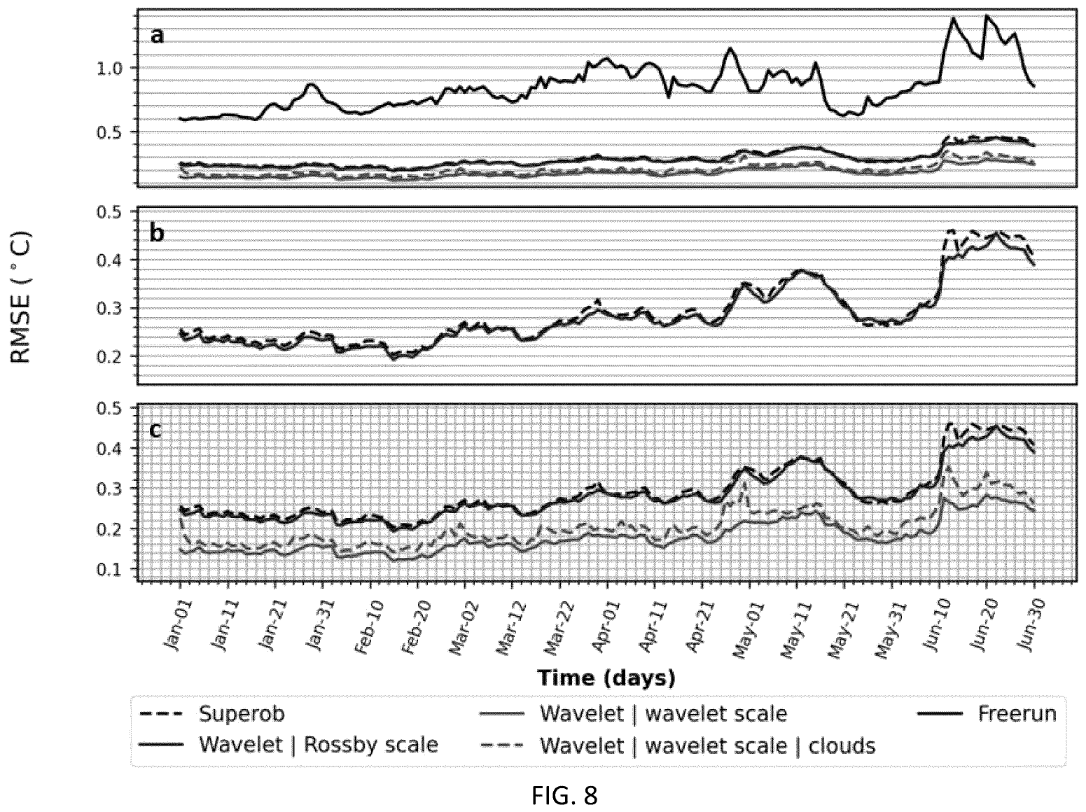

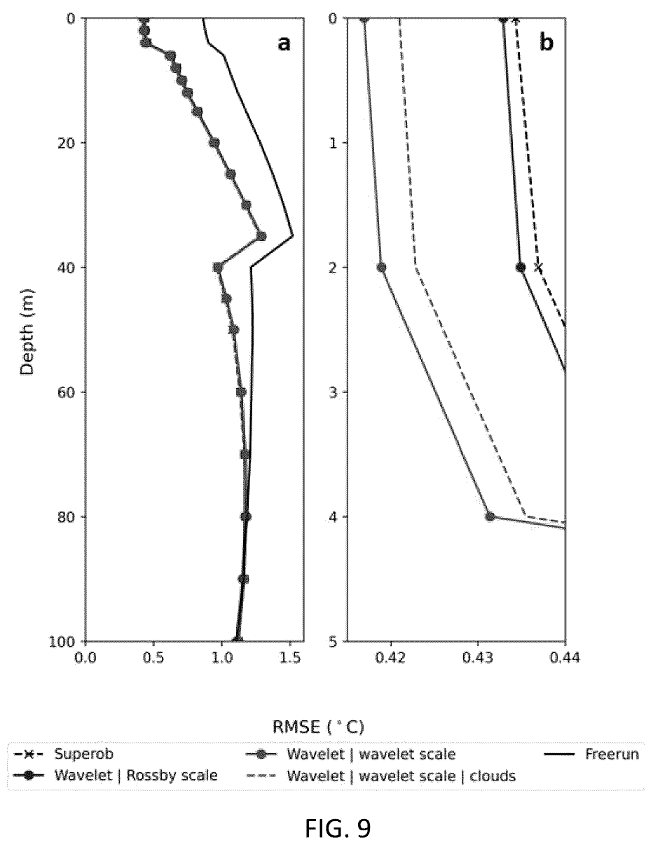

The first two columns of FIG. 7 indicate the error in the analysis from NATURE, given by Eq. 11. Only minor differences can be seen in the figure, indicating similar performance for the two methods. FIG. 8a shows that each experiment has much less RMSE than the Free run, 66% less on average. FIG. 8b shows that over the entire run wavelet-RS has slightly lower RMSE with temporally averaged difference of 2.9% over superobs. The improved surface correction over the Free run does demonstrate a considerably lower RMSE at depth, as seen in FIG. 9a, with wavelet-RS slightly outperforming superobs in the near surface (FIG. 9b). We ascribe the better performance of the wavelet experiment to the fact that as an observation operator, the wavelets are better equipped to capture smaller scale features in the observations, as seen in the comparison between FIG. 2b and FIG. 4b.

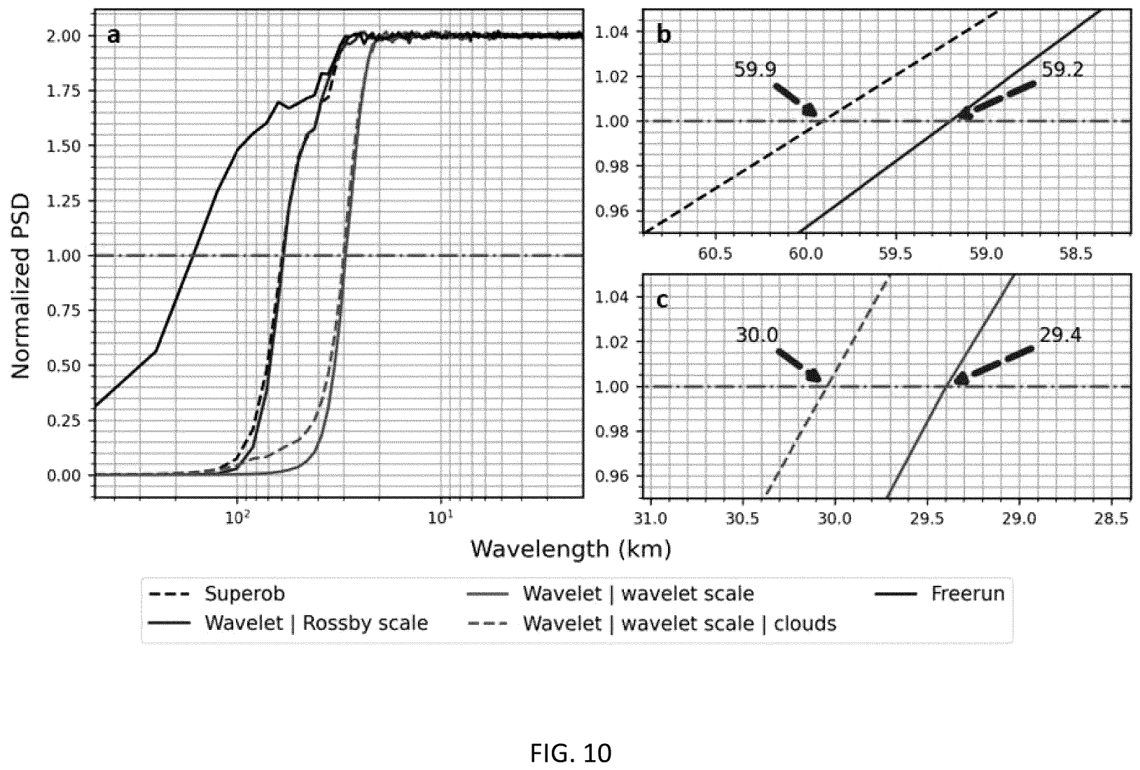

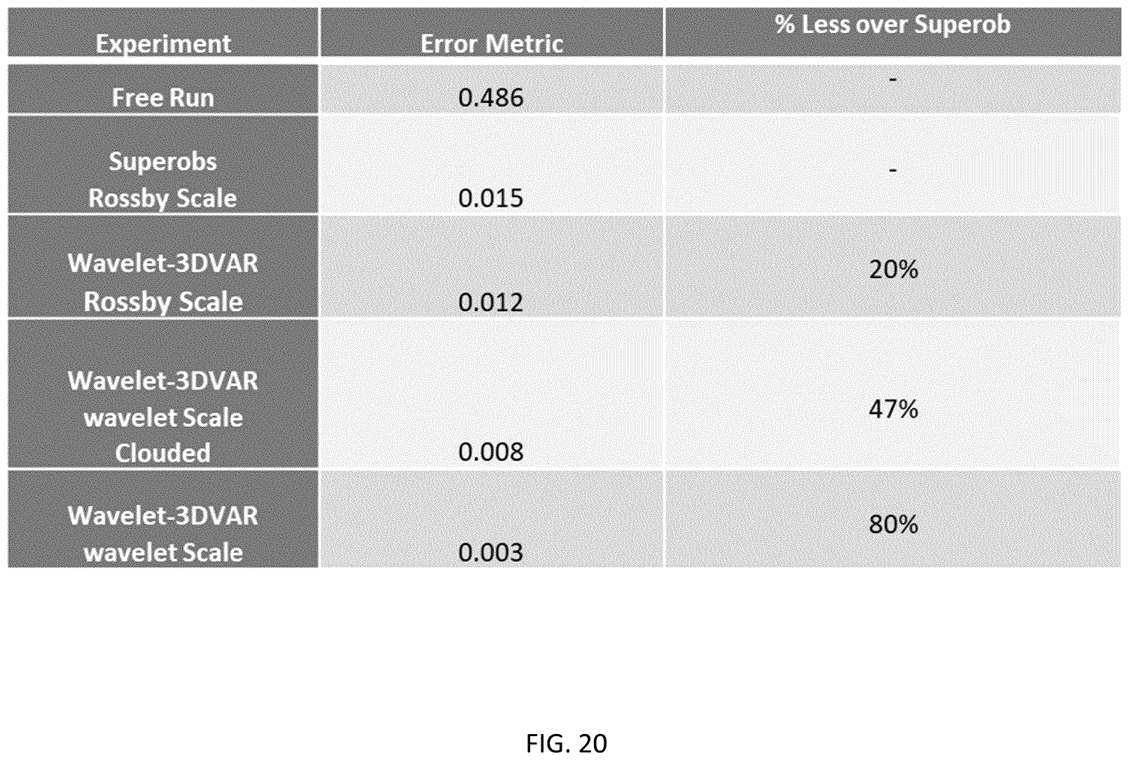

FIG. 10 demonstrates this empirically. FIG. 10a shows both experiments capture smaller scales compared to the Free run. FIG. 10b shows that wavelet-RS captures scales from 59.2 km and up compared to the 59.9 km and up for superobs. FIG. 10a also indicates that wavelet-3DVAR holds less power (i.e., higher skill) from approximately 110 km-60 km. Integrating over all wavelengths, FIG. 20 shows a table showing that 20% less power for wavelet-RS with values of 0.015 for superobs compared to the 0.012 for wavelet-RS. Thus, at the comparable Rossby scale, wavelets indicate slightly better performance in the assimilation.

However, as hypothesized in section 2.3, at three levels of wavelet decomposition there is retained horizontal information from 13 km and up (FIG. 3c) but applying the background correlation with length scales at Rossby scale, 30 km on average, there is roughly a 50% loss in assimilated horizontal information. Rossby scale is used operationally in NCODA because with a near infinite set of possible filtering scales available, the Rossby radius of deformation at least has physical justification (i.e., geostrophic assimilation). Additionally, the Rossby scale has been used historically, and still currently, because many observation types do not resolve information below these scales. The wavelet methodology need not have any such physical or historical constraints and the correlation horizontal scale should instead be based on numbers inherent in the formulation of the methodology: the number of levels of decomposition and the resulting thresholding. So, with wavelets having shown slightly better performance at comparable settings, we next evaluate wavelet assimilation using a horizontal correlation scale that better aligns with the fundamentals of the technique.

### 3.2 Wavelet Scale Comparison

Wavelet-3DVAR at wavelet scale, wavelet-WS, is the same setup as section 3.1 with the only exception that the background error correlation length scale is set to the wavelet scale as discussed in sections 2.3 and 2.4. The wavelet scale is the frequency cutoff of the wavelet approximation filter at level 3 in FIG. 3c, which has the value of: 13 km indicated by the ¼ power in the PSD. At this scale, FIG. 4c shows much smaller scale features than FIG. 4b. Assimilating these smaller scale features generates much lower error compared to wavelet-RS (FIG. 7, third column). This visually less error correlates with much less surface RMSE in FIG. 8c over the entire run. Wavelet-WS had a 38.6% temporally averaged lower RMSE difference in its favor over superobs. Comparing wavelet-RS to wavelet-WS, wavelet scale held 36.8% less RMSE on average. FIG. 9b shows a depth averaged 4% difference from superobs down to 5 m.

FIGS. 10a and 10b confirm that wavelet-WS captures smaller scales in the assimilation, with a 1.0 crossing of 29.4 km, a 51% gain over superobs. As shown in FIG. 20, integrating wavelet-WS over all wavelengths, the experiment holds 80% less power on average in the integrated normalized error when compared to superobs. We attribute this substantial reduction in error for wavelet-WS to the increased amount of captured small-scale features. Notably, these features were present in wavelet-RS above but for the “apples to apples” comparison were filtered out by the background error covariance operator set to the larger Rossby scale. So, when set to wavelet scale, these features are allowed to be retained in the wavelet assimilation and when not, the wavelet method holds slightly better performance over superobs.

3.3 Observation Sparsity with Clouded Observations

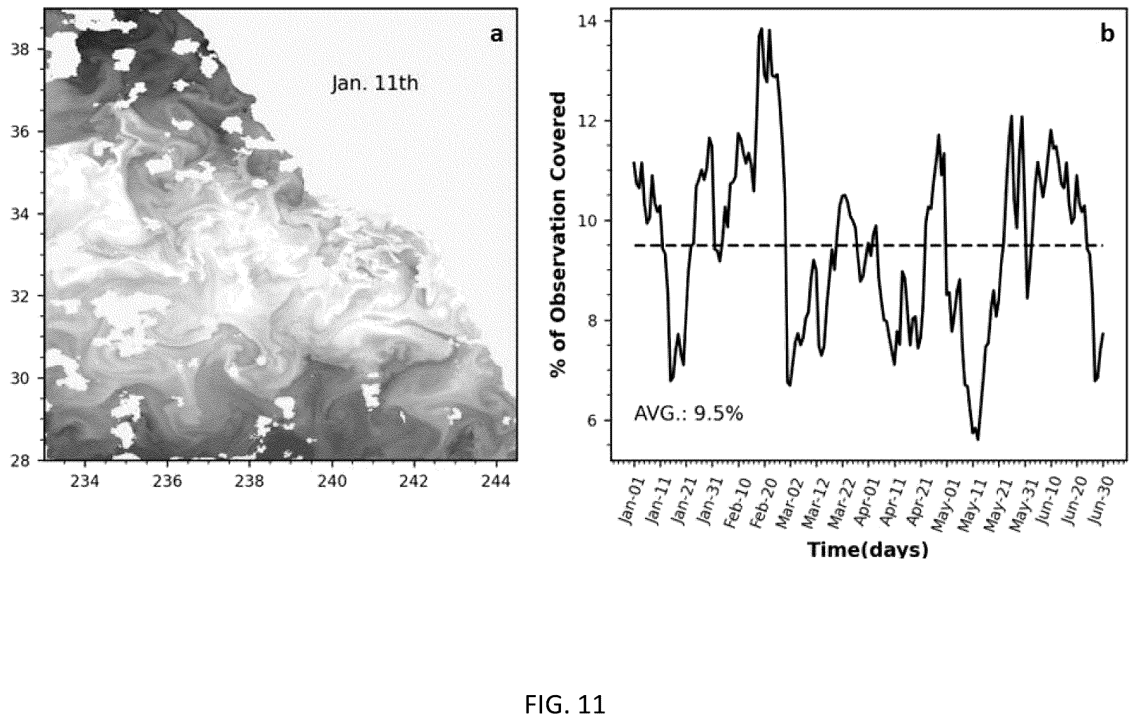

The above experiments demonstrated the wavelet-based observation operator in highly idealized scenarios in which the observations covered the entirety of the model grid at all sampled times. Real SST observations are often obscured by clouds. Here we provide a more realistic experiment, wavelet-clouds, in which the observations have been covered by simulated clouds. FIG. 11 shows an example clouded observation, with each day having 9.5% of the observation covered on average. This experiment used the same settings as section 3.2, but instead assimilated the clouded SST observations. The errors in FIG. 7 (fourth column) show very similar features to wavelet-WS errors, but with the addition of the unresolvable regions covered by clouds in the observation.

Over time, the RMSE in FIG. 8c shows a 29.7% temporally averaged difference in favor of wavelet-clouds over superobs. Wavelet-clouds also yields considerable improvement over wavelet-RS with a 27.5% temporally averaged difference in RMSE. In the vertical regime, the surface correction with clouded observations still yielded about the same performance as without the clouds. This roughly 10% difference from the 36.8% and 38.6% shown in section 3.2 for wavelet-WS correlates well with the 9.5% of the observation covered on average by the simulated clouds. Moreso, the presence of clouds did bring the normalized error above near zero around 100 km in FIG. 10a, showing some error in the larger scales as expected from clouded observations. FIG. 10c shows wavelet-clouds was still able to constrain down to approximately 30 km in the assimilation, 0.6 km less then wavelet-WS. The total integrated error for wavelet-clouds was 0.008 over all wavelengths, 47% less than superobs. Even with the expected gain in error at the larger scales from the clouds, there was still less error in the assimilation at similar wavelengths of superobs.

Because each level of wavelet decomposition creates additional edge effect errors, it was reasonable to assume that the wavelet method might be significantly impacted by the presence of significant occlusions in the observations. While we did observe reductions in skill when the clouds were present, the error reduction is approximately linear with respect to the percentage of cloud coverage. Thus, these results show that given a reasonable number of levels of decomposition, coastline- and cloud-based edge effects are not a significantly limiting factor in the overall performance of the wavelet-3DVAR method we have demonstrated here.

With observing systems ever increasing in their capabilities, the concerns addressed will only become more pertinent. Dense observations may be thinned and/or altered to comply with the decorrelation of observational errors and model noise reduction in order to achieve a timely inversion of the 3DVAR subroutine. We facilitate use of the wavelet transform as an observation operator to remove all detail coefficients. This allowed for more information to be made available at all grid points as only the smallest scale features were filtered out, based on considerations revolving around model horizontal resolution and the magnitude of spatially correlated observation errors.

Using an identical twin data assimilation experimental setup, superobs and wavelet-3DVAR assimilation methods were compared against each other. A series of error metrics showed that the wavelet-3DVAR performs the same or slightly better than superobs at NCODA operational correlation scales given by the Rossby radius of deformation. However, the wavelet-3DVAR substantially outperforms superobs when allowed its inherent correlation scale determined by the chosen wavelet and level of decomposition, with no other consequence. The increased assimilated SST information from wavelet-WS gave a temporally averaged 6-month SST RMSE of 0.18° C. compared to the 0.28° C. of the superobs, a 38.6% difference. The increase in surface information in conjunction with vertical correlations also led to improvements in the RMSE in the upper 100 m over the 6 months for the wavelet-3DVAR experiments. The inclusion of simulated clouds in the observation only reduced the surface RMSE by roughly 10%. Overall, wavelet-WS constrained 51% more scales than superobs, with a horizontal skill threshold of 29.4 km.

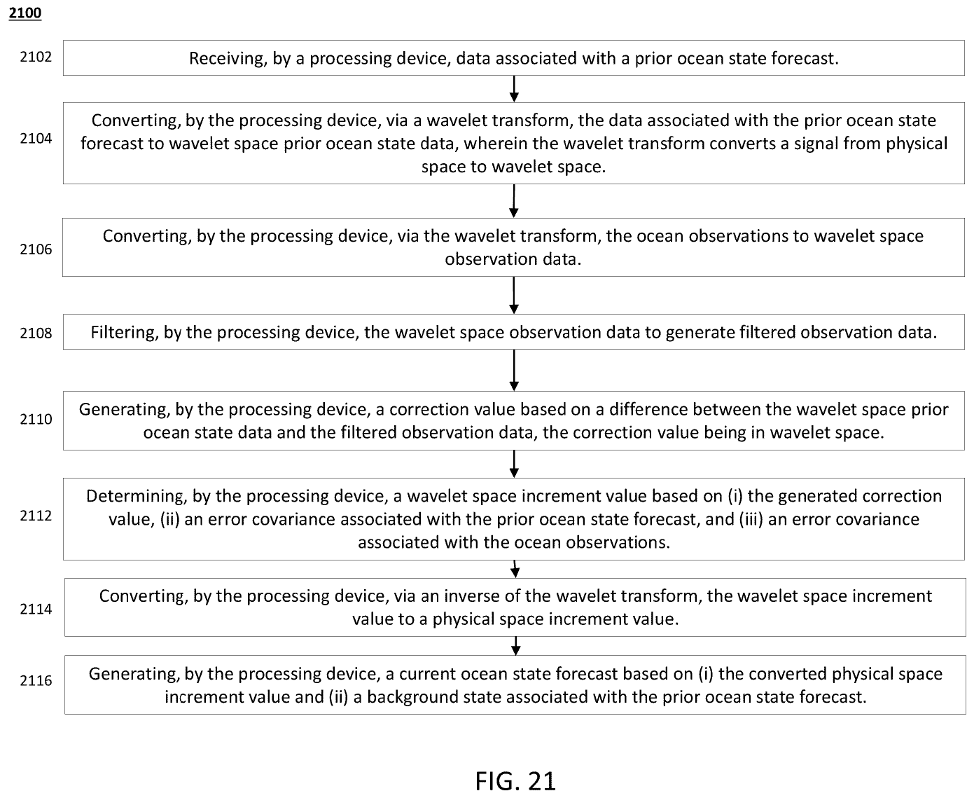

FIG. 21 illustrates an example method 2100, in accordance with one or more disclosed aspects. For example, method 2100 may be a method of forecasting an ocean state via assimilation of ocean observations. Step 2102 may include receiving, by a processing device, data associated with a prior ocean state forecast. Step 2104 may include converting, by the processing device, via a wavelet transform, the data associated with the prior ocean state forecast to wavelet space prior ocean state data, wherein the wavelet transform converts a signal from physical space to wavelet space. Step 2106 may include converting, by the processing device, via the wavelet transform, the ocean observations to wavelet space observation data. Step 2108 may include filtering, by the processing device, the wavelet space observation data to generate filtered observation data. Step 2110 may include generating, by the processing device, a correction value based on a difference between the wavelet space prior ocean state data and the filtered observation data, the correction value being in wavelet space. Step 2112 may include determining, by the processing device, a wavelet space increment value based on (i) the generated correction value, (ii) an error covariance associated with the prior ocean state forecast, and (iii) an error covariance associated with the ocean observations. Step 2114 may include converting, by the processing device, via an inverse of the wavelet transform, the wavelet space increment value to a physical space increment value. Step 2116 may include generating, by the processing device, a current ocean state forecast based on (i) the converted physical space increment value and (ii) a background state associated with the prior ocean state forecast.

One or more steps may be repeated, added, modified, and/or excluded. One or more steps may be performed by a computer, computing device, processing device, or the like, such as the one described herein and shown in FIG. 22.

According to some aspects, one or more disclosed embodiments may have one or more specific applications. According to some aspects, disclosed aspects perform compression through the wavelet transform that reduces the overall size of the data assimilation problem, making the system more efficient. According to some aspects, disclosed aspects more accurately assimilate observations across a broad range of user defined spatial scales to address various targets. Disclosed aspects deliver increased operational awareness in the ocean battlespace by more effectively exploiting currently underutilized high-resolution sea surface temperature observations. For example, ocean forecasts, such as described herein, can be used for drift prediction, search & rescue, and acoustic modeling. According to some aspects, one or more disclosed aspects may be used to develop a mission route plan associated with operating a vessel. According to some aspects, one or more disclosed aspects may be used to facilitate a water-based operation. In some cases, one or more disclosed aspects may be used to facilitate a strategic operation, which can include a defensive tactical operation or naval operation. According to some aspects, one or more disclosed embodiments can help improve accuracy and reliability of weather forecasts. For example, disclosed aspects may be used to provide better hurricane forecasts, which can help save lives, property, etc. Information about sea surface height can be used to improve seasonal to decadal coastal sea level forecasts.

One or more aspects described herein may be implemented on virtually any type of computer regardless of the platform being used. For example, as shown in FIG. 22, a computer system 2200 includes a processor 2202, associated memory 2204, a storage device 2206, and numerous other elements and functionalities typical of today's computers (not shown). The computer 2200 may also include input means 2208, such as a keyboard and a mouse, and output means 2212, such as a monitor or LED. The computer system 2200 may be connected to a local may be a network (LAN) or a wide may be a network (e.g., the Internet) 2214 via a network interface connection (not shown). Those skilled in the art will appreciate that these input and output means may take other forms.

Further, those skilled in the art will appreciate that one or more elements of the aforementioned computer system 2200 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for forecasting an ocean state via assimilation of ocean observations via a wavelet transform been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### REFERENCES

Atlas, Robert. 1997. “Atmospheric Observations and Experiments to Assess Their Usefulness.” Journal of the Meteorological Society of Japan 111-130.
Barron, C. N., R. C. Rhodes, L. F. Smedstad, C. D. Rowley, P. J. Martin, and A. B. Kara. 2002. Global Ocean Nowcasts and Forecasts with the Navy Coastal Model (NCOM). Defense Technical Information Center.
Bédard, Joël, and Mark Buehner. 2020. “A practical assimilation approach to extract smaller-scale information from observations with spatially correlated errors: An idealized study.” Quarterly Journal of the Royal Meteorological Society.
Beezley, Jonathan D., Jan Mandel, and Loren Cobb. 2011. “Wavelet ensemble Kalman filters.” Proceeding of the 6th IEEE International Conference on Intelligent Data Acquisition and Advanced Computing Systems 514-517.
Buehner, Mark, and Anna Shlyaeva. 2015. “Scale-dependent background-error covariance localisation.” Tellus A: Dynamic Meteorology and Oceanography.
Chapman, R. D., and H. C. Graber. 1997. “Validation of HF Radar Measurements.” Oceanography 76-79.
Chassignet, Eric P, Harley E Hurlburt, Ole Martin Smedstad, George R Halliwell, Patrick J Hogan, Alan J Wallcraft, Remy Baraille, and Rainer Bleck. 2007. “The HYCOM (hybrid coordinate ocean model) data assimilative system.” Journal of Marine Systems 60-83.
Cummings, James A. 2005. “Operational Multivariate ocean data assimilation.” Quarterly Journal of the Royal Meteorological Society.
D'Addezio, Joseph M., and Gregg A. Jacobs. 2022. “Scale-Dependent Ocean Vetical Correlations in the California Current System.” Geophysical Research Letters.
D'Addezio, Joseph M., Scott Smith, Gregg A. Jacobs, Robert W. Helber, Clark Rowley, Innocent Souopgui, and Matthew J. Carrier. 2019. “Quantifying wavelengths constrained by simulated SWOT observations in a submesoscale resolving ocean analysis/forecasting system.” Ocean Modelling 40-55.
Daubechies, Ingrid. 1992. Ten lectures on wavelets. SIAM.
de Rosnay, Patricia, Philip Browne, Eric de Boisséson, David Fairbairn, Yoichi Hirahara, Kenta Ochi, and et al. 2022. “Coupled data assimilation at ECMWF: current status, challenges and future developments.” Quarterly Journal of the Royal Meteorological Society 2672-2702.
Farrar, J. Thomas, Eric D'Asaro, Ernesto Rodriguez, Andrey Shcherbina, Erin Czech, Paul Matthias, Sommer Nicholas, and Frederick Bingham. 2020. “S-MODE: The Sub-Mesoscale Ocean Dynamics Experiment.” IEEE International Geoscience and Remote Sensing Symposium 3533-3536.
Hickmann, Kyle S., and Humberto C. Godinez. 2017. “A multiresolution ensemble Kalman filter using the wavelet decomposition.” Computational Geosciences 441-458.
Hoffman, Ross N. 2018. “The Effect of Thinning and Superobservations in a Simple One-Dimensional Data Analysis with Mischaracterized Error.” Monthly Weather Review 1181-1195.
Hoffman, Ross N., and Robert Atlas. 2016. “Future Observing System Simulation Experiments.” Bulletin of the American Meteorological Society 1601-1616.
Jacobs, Gregg, Joseph D'Addezio, Brent Bartels, Chris DeHaan, Charlie Barron, Matthew Carrier, Andrey Shcherbina, and Mathieu Dever. 2023. “Adapting constrained scales to observation resolution in ocean forecasts.” Ocean Modelling.
Jansen, Maarten. 2001. Noise Reduction by Wavelet Thresholding. New York: Springer.
Lagae, A., S. Lefebvre, R. Cook, T. DeRose, G. Drettakis, D. S. Ebert, J. P. Lewis, K. Perlin, and M. Zwicker. 2010. “A Survey of Procedural Noise Functions.” Computer Graphics Forum.
Li, Zhijin, James C. McWilliams, Kayo Ide, and John D. Farrara. 2015. “A Multiscale Variational Data Assimilation Scheme: Formulation and Illustration.” Monthly Weather Review 3804-3822.
Liu, Z.-Q., and F. Rabier. 2002. “The interaction between model resolution, observation resolution and observation density in data assimilation: A one-dimensional study.” Quarterly Journal of the Royal Meterological Society 1367-1386.
Martin, Paul J. 2000. “Description of the navy coastal ocean model version 1.0.” NRL Rep. NRL/FR/7322-00.
Muscarella, Philip A., M. J. Carrier, and H. E. Ngodock. 2014. “An examination of a multi-scale three-dimensional variational data assimilation scheme in the Kuroshio Extension using the naval coastal ocean model.” Continental Shelf Research.
Ngodock, Hans, Matthew Carrier, Innocent Souopgui, Scott Smith, Paul Martin, Philip Muscarella, and Gregg Jacobs. 2016. “On the direct assimilation of along-track sea-surface height observations into a free-surface ocean model using a weak constraints four-dimensional variational (4D-Var) method.” Quarterly Journal of the Royal Meteorological Society 1160-1170.
Ochotta, Tilo, Constanze Gebhardt, Vladimir Bondatenko, Dietmar Saupe, and Werner Wergen. 2007. “On thinning methods for data assimimlation of satellite observations.” International Conference on IIPS for Meteorology, Oceanography and Hydrology.
Penny, S. G., T. A. Smith, T.-C. Chen, J. A. Platt, H.-Y. Lin, M. Goodliff, and H. D. I. Abarbanel. 2022. “Integrating Recurrent Neural Networks With Data Assimilation for Scalable Data-Driven State Estimation.” Journal of Advances in Modeling Earth Systems.
Rhif, Manel, Ali Ben Abbes, Imed Riadh Farah, Beatriz Martinez, and Yanfang Sang. 2019. “Wavelet Transform Application for/in Non-Stationary Time-Series Analysis: A Review.” Applied Sciences 1345.
Richman, James G., Brian K. Arbic, Jay F. Shriver, E. Joseph Metzger, and Alan J. Wallcraft. 2012. “Inferring dynamics from the wavenumber spectra of an eddying global ocean model with embedded tides.” Journal of Geophysical Research Oceans.
Roache, P. J. 1998. Fundamentals of Computational Fluid Dynamics. Albuquerque: Hermosa Publishers.
Rodriguez, Ernesto, Alexander Wineteer, Dragana Perkovic-Martin, Tamás Gál, Bryan W. Stiles, Noppasin Niamsuwan, and Raquel Rodriguez Monje. 2018. “Estimating Ocean Vector Winds and Currents Using a Ka-Band Pencil-Beam Doppler Scatterometer.” Remote Sensing.
Rosemary, Morrow, Fu Lee-Lueng, Ardhuin Fabrice, Benkiran Mounir, Chapron Bertrand, Cosme Emmanuel, d'Ovidio Francesco, et al. 2019. “Global Observations of Fine-Scale Ocean Surface Topography With the Surface Water and Ocean Topography (SWOT) Mission.” Frontiers in Marine Science.
Roy, T. K., and M. Morshed. 2013. “Performance analysis of low pass FIR filters design using Kaiser, Gaussian and Tukey window function methods.” 2013 2nd International Conference on Advances in Electrical Engineering (ICAEE).
S. A. Haben, A. S. Lawless and N. K. Nichols. 2009. “Conditioning of the 3DVAR Data Assimilation.” Dept. of Mathematics, Univerty of Reading.
Souopgui, Innocent, Joseph M. D'Addezio, Clark D. Rowley, Scott R. Smith, Gregg A. Jacobs, Robert W. Helber, Max Yaremchuk, and John J. Osborne. 2020. “Multi-scale assimilation of simulated SWOT observations.” Ocean Modelling.
Souopgui, Innocent, Scott A. Wieland, M. Yousuff Hussaini, and Oleg V. Vasilyev. 2016. “Space-time adaptive approach to variational data assimilation using wavelets.” Journal of Computational Physics 253-268.
Strang, Gilbert. 1996. Wavelets and filter banks.
Su, Zhan, Jinbo Wang, Patrice Klein, Andrew F. Thompson, and Dimitris Menemenlis. 2018. “Ocean submesoscales as a key component of the global heat budget.” Nature Communications.
Tangborn, Andrew. 2004. “Wavelet approximation of error covariance propagation in data assimilation.” Tellus A: Dynamic Meteorology and Oceanography 16-28.
Torres, H., A. Wineteer, P. Klein, T. Lee, J. Wang, E. Rodriguez, D. Menemenlis, and H. Zhang. 2023. “Anticipated Capabilities of the ODYSEA Wind and Current Mission Concept to Estimate Wind Work at the Air-Sea Interface.” Remote Sensing.
Valens, C. 1999. “A Really Friendly Guide to Wavelets.”
Wang, Xuguang, Hristo G. Chipilski, Craig H. Bishop, Elizabeth Satterfield, Nancy Baker, and Jeffrey S. Whitaker. 2021. “A Multiscale Local Gain Form Ensemble Transform Kalman Filter (MLGETKF).” Monthly Weather Review.
Wasilewski, Filip. n.d. Wavelet Browser by pywavelets. Accessed 2023. https://wavelets.pybytes.com/.
Winkler, Joab R. 2000. “Orthogonal Wavelets via Filter Banks: Theory and Applications.”
Ying, Yue. 2020. “Assimilating Observations with Spatially Correlated Errors Using a Serial Ensemble Filter with a Multiscale Approach.” Monthly Weather Review.
Yu, Liuqian, Katja Fennel, Bin Wang, Arnaud Laurent, Keith R Thompson, and Lynn K Shay. 2019. “Evaluation of fraternal versus identical twin approaches for observation impact assessments: An EnKF-based ocean assimilation application for the Gulf of Mexico.” Ocean science discussions 1-36.

What is claimed is:

1. A method of forecasting an ocean state via assimilation of ocean observations, the method comprising:
receiving, by a processing device, data associated with a prior ocean state forecast;
converting, by the processing device, via a wavelet transform, the data associated with the prior ocean state forecast to wavelet space prior ocean state data, wherein the wavelet transform converts a signal from physical space to wavelet space;
converting, by the processing device, via the wavelet transform, the ocean observations to wavelet space observation data;
filtering, by the processing device, the wavelet space observation data to generate filtered observation data;
generating, by the processing device, a correction value based on a difference between the wavelet space prior ocean state data and the filtered observation data, the correction value being in wavelet space;
determining, by the processing device, a wavelet space increment value based on (i) the generated correction value, (ii) an error covariance associated with the prior ocean state forecast, and (iii) an error covariance associated with the ocean observations;
converting, by the processing device, via an inverse of the wavelet transform, the wavelet space increment value to a physical space increment value; and
generating, by the processing device, a current ocean state forecast based on (i) the converted physical space increment value and (ii) a background state associated with the prior ocean state forecast.

2. The method of claim 1, wherein the wavelet transform comprises a convolution operation resulting in a decomposed frequency associated with a signal or a wavenumber space associated with a signal.

3. The method of claim 2, wherein the convolution operation includes using a mother wavelet function associated with one or more basis functions.

4. The method of claim 3, wherein selection of the mother wavelet function is based on a specified target associated with the ocean observations.

5. The method of claim 3, wherein the inverse of the wavelet transform is orthogonal to the one or more basis functions associated with the mother wavelet function.

6. The method of claim 1, wherein the wavelet transform decomposes the ocean observations into an approximation, horizontal details, vertical details, and diagonal details, wherein the approximation comprises a low-pass representation of the ocean observations, and wherein the horizontal details, vertical details, and diagonal details are different high-pass representations of the ocean observations.

7. The method of claim 6, further comprising recursively decomposing the approximation, wherein each recursion comprises decomposing the resulting approximation from a previous decomposing step.

8. The method of claim 7, further comprising recursively decomposing the approximation a predetermined number of times.

9. The method of claim 7, further comprising recursively decomposing the approximation until a resulting approximation can no longer be divided by two.

10. The method of claim 7, wherein the filtering comprises filtering the wavelet space data based on a desired spatial scale associated with a level of decomposition.

11. The method of claim 10, wherein the filtering comprises removing one or more detail coefficients associated with the high-pass representations leaving behind the approximation at a final level of decomposition.

12. The method of claim 1, wherein the wavelet space increment value is determined based on an observation operator.

13. The method of claim 1, further comprising assimilating the filtered observation data before generating the correction value.

14. The method of claim 11, wherein the assimilating is performed via a Navy Coupled Ocean Data Assimilation (NCODA) system.

15. The method of claim 1, wherein the prior ocean state forecast comprises one or more of the following: sea surface temperature (SST), in situ profiles of temperature and/or salinity, or sea surface height (SSH).

16. The method of claim 1, further comprising performing a water-based operation based on the generated current ocean state forecast.

17. The method of claim 1, wherein the ocean observations capture multiple scales of motion.

18. The method of claim 1, wherein at least a portion of the ocean observations are captured via a satellite system.
